(19) United States
(12) Patent Application Publication
(10) Pub. No.: US 2025/0242428 A1
(43) Pub. Date: Jul. 31, 2025

(54) LAMINATION DESIGN METHOD, WELDING CONDITION SETTING METHOD, WELDING CONTROL METHOD, WELDING CONTROL DEVICE, AND WELDING SYSTEM

(71) Applicant: KOBELCO ROBOTiX Co., Ltd., Fujisawa-shi (JP)

(72) Inventors: Futoshi NAKATA, Kanagawa (JP); Hirofumi KAWASAKI, Kanagawa (JP); Shinobu TODA, Kanagawa (JP); Masaru KODAMA, Kanagawa (JP)

(73) Assignee: KOBELCO ROBOTiX Co., Ltd., Fujisawa-shi (JP)

(21) Appl. No.: 18/856,795

(22) PCT Filed: Aug. 2, 2022
(86) PCT No.: PCT/JP2022/029719

§ 371 Date: Oct. 14, 2024

(30) Foreign Application Priority Data
Apr. 22, 2022 (JP) 2022-071123

(51) Int. Cl. B23K 9/095; B23K 9/127

(52) U.S. Cl. CPC B23K 9/0953; B23K 9/127

(57) ABSTRACT

A lamination design method is capable of generally and easily setting welding conditions regardless of whether long welding is performed or not while securing welding quality. A lamination design method for performing multilayer overlay welding on a material to be welded provided with a groove shape using a welding robot includes: detecting a plurality of the groove shapes; calculating reference groove shape data based on a detected plurality of pieces of groove shape data; calculating at least the number of lamination layers and a layer thickness of each layer as reference lamination information based on the reference groove shape data; and calculating the number of lamination layers and a layer thickness of each layer as lamination information of each detection position based on the reference groove shape data, the groove shape data of each detection position, and the reference lamination information.

### TECHNICAL FIELD

The present disclosure relates to a lamination design method, a welding condition setting method, a welding control method, a welding control device, and a welding system.

### BACKGROUND ART

In the manufacture of welded structures on ships, steel frames, bridges, and the like, an automatic welding system to which a robot is applied is frequently used in a welding operation with an emphasis on operation efficiency. This automatic welding system is preferable to be easily handled even by an unskilled worker, and in particular, it is desirable to automatically generate welding conditions, which requires time to be set manually even by a skilled worker depending on experience.

Regarding the setting of the welding conditions, for example, there is Patent Literature 1. Patent Literature 1 describes a technique in which, in automatic welding in which the number of welding paths and each path welding condition are automatically generated based on a groove shape, and the welding of each path is automatically performed under each generated path welding condition, the number of paths required to fill a groove cross-sectional area is calculated, the calculated number of paths is set to an integer value by rounding up a fractional value, and the integer value is determined as the number of welding paths, a travel speed is corrected to a travel speed at which an increase in weld amount is cancelled by rounding up a fractional value, and automatic welding is performed at the determined number of welding paths and the corrected travel speed.

### CITATION LIST

### Patent Literature

Patent Literature 1: JP 2019-126819A

### SUMMARY OF INVENTION

### Technical Problem

The actual welding may be welding with a short welding length or long welding with a long welding length depending on a welding location of a target welded structure. As the target welded structure becomes larger, a ratio of long welding becomes larger. Here, in the case of multilayer overlay welding, generally, a material to be welded (hereinafter, also referred to as “base metal”) is subjected to a groove processing, assembly and temporary welding of the material to be welded are performed, and then welding is performed based on a groove shape, and the accuracy of the groove processing and the assembly accuracy of the material to be welded become worse as a size of the target welded structure becomes larger. That is, the longer the long welding is, the more likely it is to be adversely affected by the accuracy of the groove processing or the assembling accuracy of the material to be welded, and thus depending on a groove position, groove shape data may vary and the welding groove may bend. The groove shape data includes a root gap (hereinafter, also referred to as a gap), a groove angle, a staggered amount, and the like.

In Patent Literature 1, no consideration is given to the problem of the variation of the groove shape data and the bending of the welding groove when there is a long welding, and defects such as undercuts and overlaps may occur along an entire length of a welding line, and it may become difficult to ensure a designed welding bead width and weld reinforcement height. In the related art, a work of increasing the number of locations for detecting a groove shape and a work of shifting a detection position are required, and it is necessary to change a program every time welding is performed, which decreases a work efficiency and makes a work difficulty level high.

Therefore, in the welding of the target welded structure, it is required that welding conditions can be set widely and easily regardless of whether long welding is performed or not, and in order to achieve the setting of the welding conditions, it is necessary to consider a lamination design, which is the basis for setting the welding conditions.

Therefore, in one or more embodiments of the present invention, an object thereof is to provide a lamination design method, a welding condition setting method, a welding control method, a welding control device, and a welding system capable of generally and easily setting welding conditions regardless of whether long welding is performed or not while securing welding quality.

### Solution to Problem

Therefore, the above object of the present invention is achieved by the following configuration [1].

[1] A lamination design method for performing multilayer overlay welding on a material to be welded provided with a groove shape using a welding robot, the lamination design method including:
detecting a plurality of the groove shapes;
calculating reference groove shape data based on a detected plurality of pieces of groove shape data;
calculating at least the number of lamination layers and a layer thickness of each layer as reference lamination information based on the reference groove shape data; and
calculating the number of lamination layers and a layer thickness of each layer as lamination information of each detection position based on the reference groove shape data, the groove shape data of each detection position, and the reference lamination information.

The above object of the present invention is achieved by the following configuration [2].

[2] A welding condition setting method for determining a welding condition, including:
determining and setting at least one welding condition among a welding current, a feeding speed, an arc voltage, a travel speed, a weaving width, and a target position of a wire based on the reference lamination information or the lamination information of each detection position calculated in the lamination design method according to [1].

The above object of the present invention is achieved by the following configuration [3].

[3] A welding control method for performing multilayer overlay welding on a material to be welded provided with a groove shape using a welding robot, the welding control method including:
a groove shape detection step of detecting a plurality of the groove shapes;
a reference groove shape calculation step of calculating reference groove shape data based on a detected plurality of pieces of groove shape data;
a reference lamination information calculation step of calculating at least the number of lamination layers and a layer thickness of each layer as reference lamination information based on the reference groove shape data;
a welding condition setting step of determining and setting at least one welding condition among a welding current, an arc voltage, a travel speed, and a weaving width based on the reference lamination information; and
a detection position calculation step of calculating lamination information of each detection position or a welding condition of each detection position based on at least one of the reference lamination information and the welding condition, the reference groove shape data, and the groove shape data of each detection position.

The above object of the present invention is achieved by the following configuration [4].

[4] A welding control device for performing multilayer overlay welding on a material to be welded provided with a groove shape using a welding robot, the welding control device including:
a groove shape detection function of detecting a plurality of the groove shapes;
a reference groove shape calculation function of calculating reference groove shape data based on a detected plurality of pieces of groove shape data;
a reference lamination information calculation function of calculating at least the number of lamination layers and a layer thickness of each layer as reference lamination information based on the reference groove shape data;
a welding condition setting function of determining and setting at least one welding condition among a welding current, an arc voltage, a travel speed, and a weaving width based on the reference lamination information; and
a detection position calculation function of calculating lamination information of each detection position or a welding condition of each detection position based on at least one of the reference lamination information and the welding condition, the reference groove shape data, and the groove shape data of each detection position.

The above object of the present invention is achieved by the following configuration [5].

[5] A welding system for performing multilayer overlay welding on a material to be welded provided with a groove shape using a welding robot, the welding system including:
at least a control device; and a welding power source, in which
the control device has:
a groove shape detection function of detecting a plurality of the groove shapes;
a reference groove shape calculation function of calculating reference groove shape data based on a detected plurality of pieces of groove shape data;
a reference lamination information calculation function of calculating at least the number of lamination layers and a layer thickness of each layer as reference lamination information based on the reference groove shape data;
a welding condition setting function of determining and setting at least one welding condition among a welding current, an arc voltage, a travel speed, and a weaving width based on the reference lamination information; and
a detection position calculation function of calculating lamination information of each detection position or a welding condition of each detection position based on at least one of the reference lamination information and the welding condition, the reference groove shape data, and the groove shape data of each detection position.

### Advantageous Effects of Invention

According to the present disclosure, it is possible to provide a lamination design method, a welding condition setting method, a welding control method, a welding control device, and a welding system capable of generally and easily setting welding conditions regardless of whether long welding is performed or not while securing welding quality.

### BRIEF DESCRIPTION OF DRAWINGS

FIG. 1 is a schematic diagram illustrating a configuration of a welding system according to an embodiment of the present disclosure.

FIG. 2 is a schematic diagram illustrating a configuration of a portable welding robot according to the embodiment of the present disclosure.

FIG. 3 is a perspective view illustrating a configuration of the portable welding robot according to the embodiment of the present disclosure.

FIG. 4 is a conceptual diagram illustrating an approximate linear movement mechanism according to the embodiment of the present disclosure.

FIG. 5 is a schematic perspective view illustrating a case in which the portable welding robot is disposed on a straight guide rail with respect to a groove including a curve according to the embodiment of the present disclosure.

FIG. 6 is a perspective view illustrating a plurality of detection positions according to the embodiment of the present disclosure.

FIG. 7 is a schematic diagram illustrating touch sensing according to the embodiment of the present disclosure.

FIG. 8 is a conceptual diagram illustrating a lamination design according to the embodiment of the present disclosure.

FIG. 9 is a schematic cross-sectional view of a weld joint according to the embodiment of the present disclosure.

FIG. 10 is a diagram illustrating layer thickness information according to the embodiment of the present disclosure.

FIG. 11 is a flowchart illustrating a determination processing of the number of lamination layers and a layer thickness according to the embodiment of the present disclosure.

FIG. 12 is a conceptual diagram illustrating a situation in which a layer thickness of an intermediate layer of priority 4 is set to a lower limit value.

FIG. 13 is a conceptual diagram illustrating a situation in which a layer thickness of a second layer of priority 3 is reduced from an upper limit value to an appropriate value.

FIG. 14 is a conceptual diagram illustrating a situation in which a layer thickness of a surface layer of priority 2 is reduced to an appropriate value.

FIG. 15 is a conceptual diagram illustrating a layer width according to the embodiment of the present disclosure.

FIG. 16 is a diagram illustrating distribution threshold information according to the embodiment of the present disclosure.

FIG. 17 is a conceptual diagram illustrating distribution paths for each layer and a cross-sectional area for each path according to the embodiment of the present disclosure.

FIG. 18 is a conceptual diagram illustrating path classification according to the embodiment of the present disclosure.

FIG. 19 is a conceptual diagram illustrating a case in which there are a plurality of mid-groove paths according to the embodiment of the present disclosure.

FIG. 20 is a diagram illustrating welding current information according to the embodiment of the present disclosure.

FIG. 21 is a conceptual diagram illustrating parameters for determining an appropriate target position of a wire according to the embodiment of the present disclosure.

FIG. 22 is a diagram illustrating target position parameters according to the embodiment of the present disclosure.

FIG. 23 is a conceptual diagram illustrating target position parameters according to the embodiment of the present disclosure.

FIG. 24 is a conceptual diagram illustrating target positions of the wire according to the embodiment of the present disclosure.

FIG. 25 is a conceptual diagram illustrating a target position of the wire according to the embodiment of the present disclosure.

FIG. 26 is a conceptual diagram illustrating a target position of the wire according to the embodiment of the present disclosure.

FIG. 27 is a diagram illustrating a management table that manages parameters related to the determination of the number of layers, the number of paths, a wire target position, and a weaving width according to the embodiment of the present disclosure.

FIG. 28 is a diagram illustrating a management table that manages parameters related to the determination of a weld amount and an arc voltage according to the embodiment of the present disclosure.

FIG. 29 is a diagram illustrating selection items of welding according to the embodiment of the present disclosure.

FIG. 30 is a conceptual diagram illustrating groove shapes at a plurality of detection positions according to the embodiment of the present disclosure.

### DESCRIPTION OF EMBODIMENTS

Hereinafter, a welding system according to an embodiment of the present invention will be described with reference to the drawings. The present embodiment is an example of a case in which a portable welding robot is used. The welding system of the present invention is not limited to the configuration of the present embodiment.

The unnecessarily detailed description may be omitted. For example, the detailed description of already well-known matters or the redundant description of substantially the same configuration may be omitted. This is to prevent the following description from being unnecessarily redundant and to facilitate understanding by those skilled in the art. The accompanying drawings and the following description are provided for those skilled in the art to sufficiently understand the present disclosure, and are not intended to limit the subject matter described in the claims.

For example, the “portion” or the “device” in the embodiment is not limited to a physical configuration that is mechanically implemented simply by hardware, and includes a configuration in which functions of the physical configuration are implemented by software such as a program. A function of one configuration may be implemented by two or more physical configurations, or functions of two or more configurations may be implemented by, for example, one physical configuration.

### Configuration of Welding System

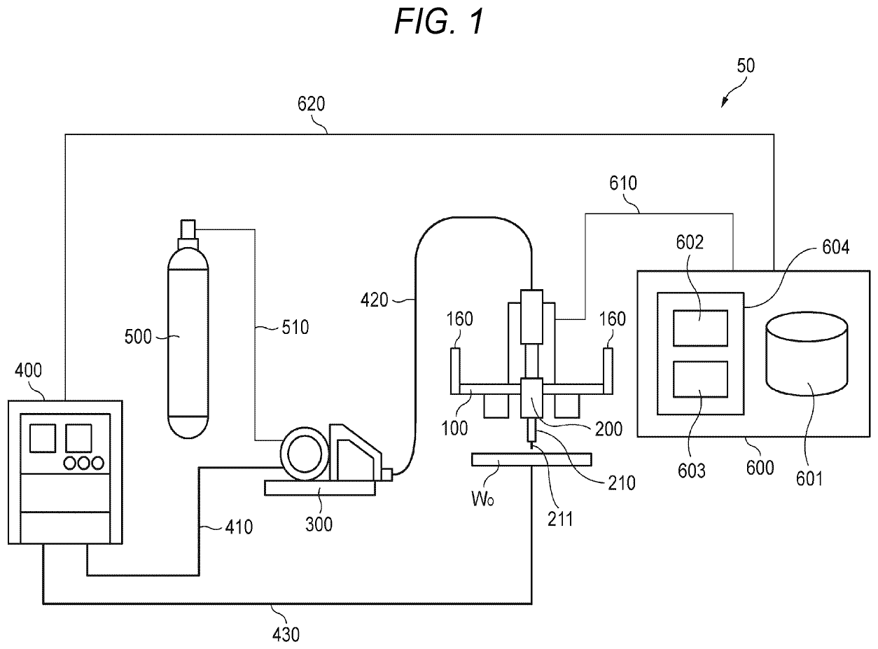

FIG. 1 is a schematic diagram illustrating a configuration of the welding system according to an embodiment of the present disclosure. As illustrated in FIG. 1, a welding system 50 includes a portable welding robot 100, a feeding device 300, a welding power source 400, a shield gas supply source 500, and a control device 600.

### Control Device

The control device 600 corresponding to a control device of the present disclosure is connected to the portable welding robot 100 by a robot control cable 610, and is connected to the welding power source 400 by a power source control cable 620. The control device 600 includes a data holding unit 601 that holds teaching data in which an operation pattern, a welding start position, a welding end position, working conditions, welding conditions, and the like of the portable welding robot 100 are determined in advance, and transmits commands to the portable welding robot 100 and the welding power source 400 based on the teaching data to control an operation and the welding conditions of the portable welding robot 100. The control device 600 may include a memory, and the data holding unit 601 may be provided in the memory. The memory corresponds to a storage device.

The control device 600 includes a control unit 604. The control unit 604 includes a groove shape information calculation unit 602 that calculates groove shape information based on detection data obtained by sensing to be described later, and a welding condition acquisition unit 603 that corrects and acquires the welding conditions of the teaching data based on the groove shape information. The control unit 604 may further include a functional block that implements other functions. The control unit 604 may include a processor, and performs various types of information processing in the control device 600.

The control device 600 has a control program for controlling the portable welding robot 100. The control program is stored in the storage device such as the memory of the control device 600. The portable welding robot 100 is controlled by a processor provided in the control device 600 reading and executing the control program. The control program has various functions related to the control of the portable welding robot 100.

In addition, although not illustrated because of a general configuration, the control device 600 is integrally formed with a controller for performing teaching, manual operation of the portable welding robot 100, and the like, and a controller having other control functions. The control device 600 is not limited thereto, and may be divided into a plurality of controllers depending on roles, such as being divided into two, that is, a controller for performing teaching and a controller having other control functions, or the control device 600 may be provided in the portable welding robot 100. In the present embodiment, a signal is transmitted using the robot control cable 610 and the power source control cable 620, and the present invention is not limited thereto, and the signal may be transmitted wirelessly. From the viewpoint of usability at a welding site, it is preferred that the controller is divided into two, that is, a controller for teaching, manual operation of the portable welding robot 100, and the like, and a controller having other control functions.

### Welding Power Source

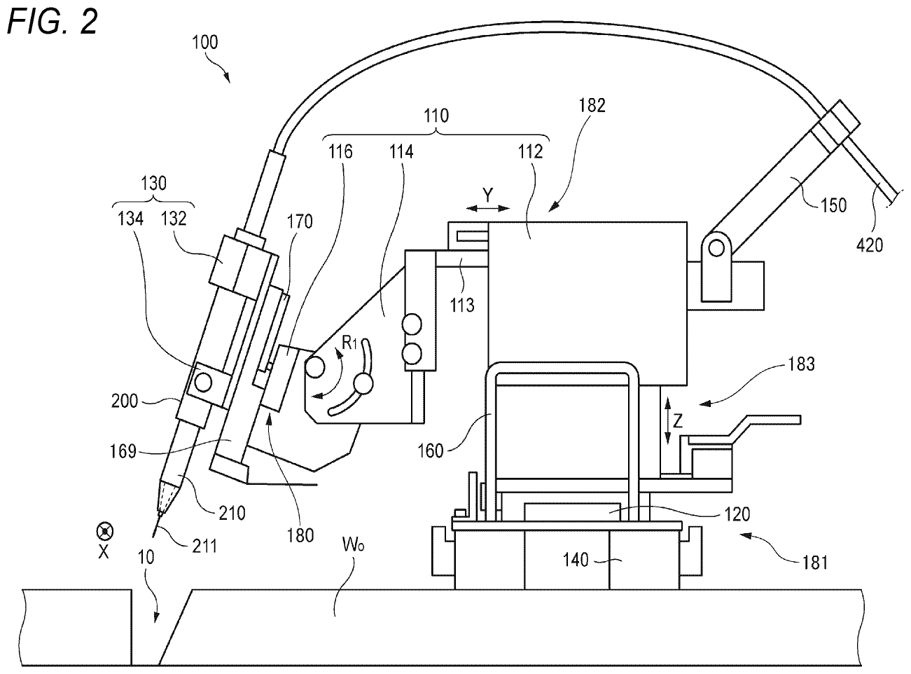

The welding power source 400 generates an arc between a welding wire 211 and a workpiece Wo by supplying electric power to the welding wire 211 and the workpiece Wo which are consumable electrodes according to a command from the control device 600. The electric power from the welding power source 400 is sent to the feeding device 300 via a power cable 410, and is sent from the feeding device 300 to a welding torch 200 via a conduit tube 420. As illustrated in FIG. 2, which is a schematic diagram illustrating a configuration of the portable welding robot according to the embodiment of the present disclosure, the electric power from the welding power source 400 is supplied to the welding wire 211 via a contact tip at a tip end of the welding torch 200. A current during a welding operation may be a direct current or an alternating current, and a waveform thereof is not particularly limited. Therefore, the current may be a pulse such as a rectangular wave or a triangular wave.

The welding power source 400 is connected to a welding torch 200 side with the power cable 410 as a positive electrode and connected to the workpiece Wo with a power cable 430 as a negative electrode, for example. When welding is performed with an opposite polarity, a power cable serving as a positive electrode may be connected to a workpiece Wo side, and when welding is performed with a positive polarity, a power cable serving as a negative electrode may be connected to the welding torch 200 side.

### Shield Gas Supply Source

The shield gas supply source 500 includes a container in which shield gas is sealed, and an accessory member such as a valve. The shield gas is sent from the shield gas supply source 500 to the feeding device 300 via a gas tube 510. The shield gas sent to the feeding device 300 is sent to the welding torch 200 via the conduit tube 420. The shield gas sent to the welding torch 200 flows through the welding torch 200, is guided to a nozzle 210, and is ejected from a tip end side of the welding torch 200. The shield gas used in the present embodiment can be, for example, argon (Ar), carbon dioxide (CO₂), or a mixture of these gases, but it is preferred to use 100% CO₂ gas for welding.

### Feeding Device

The feeding device 300 feeds the welding wire 211 to the welding torch 200. The welding wire 211 fed by the feeding device 300 is not particularly limited, and is selected according to properties of the workpiece Wo, a welding form, and the like, and for example, a solid wire or a flux-cored wire is used. A wire diameter of a welding wire is not particularly limited, and an upper limit value is preferably 1.6 mm and a lower limit value of the wire diameter is preferably 0.9 mm in the present embodiment.

The conduit tube 420 according to the present embodiment has a conductive path that is formed on an outer skin side of the tube and functions as a power cable, a protective tube that is disposed inside the tube and protects the welding wire 211, and a flow path for the shield gas.

The conduit tube 420 is not limited thereto, and for example, a bundle of an electric power supply cable or a shield gas supply hose around a protective tube for feeding the welding wire 211 to the welding torch 200 may be used. Further, for example, a tube for feeding the welding wire 211 and the shield gas, and the power cable can also be separately disposed.

### Portable Welding Robot

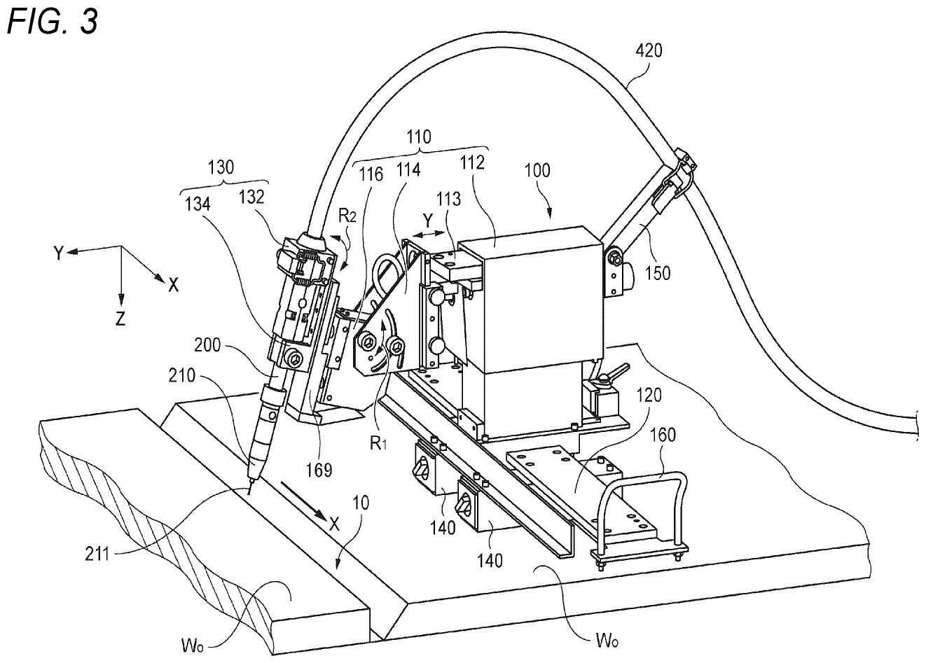

As illustrated in FIGS. 2 and 3, the portable welding robot 100 includes a guide rail 120, a robot main body 110 disposed on the guide rail 120 and moving along the guide rail 120, and a torch connection portion 130 placed on the robot main body 110. FIG. 3 is a perspective view illustrating a configuration of the portable welding robot according to the embodiment of the present disclosure. The robot main body 110 mainly includes a main body portion 112 disposed on the guide rail 120, a fixing arm portion 114 attached to the main body portion 112, and a welding torch rotation drive portion 116 attached to the fixing arm portion 114 in a state of being rotatable in an arrow R₁ direction.

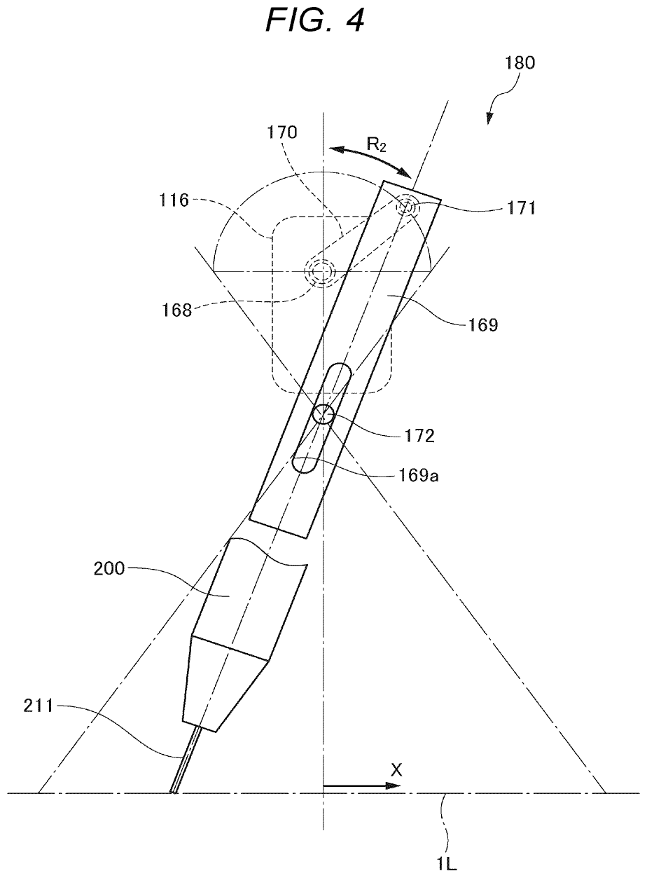

FIG. 4 is a conceptual diagram illustrating an approximate linear movement mechanism according to the embodiment of the present disclosure. As illustrated in FIG. 4, the torch connection portion 130 is attached to the welding torch rotation drive portion 116 via a sliding table 169 and a crank 170. The torch connection portion 130 includes a torch clamp 132 and a torch clamp 134 which fix the welding torch 200. In addition, the main body portion 112 is provided with a cable clamp 150 that supports the conduit tube 420 connecting the feeding device 300 and the welding torch 200 on a side opposite to a side on which the welding torch 200 is mounted.

In the present embodiment, a voltage is applied between the workpiece Wo and the welding wire 211, and a touch sensor that senses a surface or the like of a groove 10 using a voltage drop phenomenon that occurs when the welding wire 211 comes into contact with the workpiece Wo is used as a detection unit. The detection unit is not limited to the touch sensor of the present embodiment, an image sensor, a laser sensor, or a combination of these detection units may be used, and it is preferred to use the touch sensor of the present embodiment because of the convenience of the device configuration.

As indicated by an arrow X in FIG. 2, the main body portion 112 of the robot main body 110 includes an X-axis movement mechanism 181 that moves the robot main body 110 along the guide rail 120 in an X-axis direction that is a direction perpendicular to a plane in FIG. 2 and is a welding direction. The main body portion 112 further includes a Y-axis movement mechanism 182 that moves the fixing arm portion 114 in a Y-axis direction, which is a width direction of the groove 10 and is perpendicular to the X-axis direction and a Z-axis direction with respect to the main body portion 112 via a slide support portion 113. The main body portion 112 further includes a Z-axis movement mechanism 183 that moves the robot main body 110 in a depth direction of the groove 10 perpendicular to the X-axis direction.

Further, as illustrated in FIG. 4, the sliding table 169, the crank 170, and the welding torch rotation drive portion 116 to which the torch connection portion 130 is attached constitute an approximate linear movement mechanism 180 that moves a tip end of the welding wire 211 along an approximate straight line to be described later.

Specifically, the crank 170 is fixed to a rotation shaft 168 of a motor (not illustrated) fixed to the welding torch rotation drive portion 116, and a tip end of the crank 170 is coupled to one end of the sliding table 169 by a coupling pin 171. The sliding table 169 includes a long groove 169a in an intermediate portion thereof, and a fixing pin 172 fixed to the welding torch rotation drive portion 116 is slidably fitted into the long groove 169a.

Accordingly, when the crank 170 pivots about the rotation shaft 168 by the motor (not illustrated), the sliding table 169 pivots about the fixing pin 172 as a fulcrum, and moves along the long groove 169a while being guided by the fitted fixing pin 172. That is, the torch connection portion 130 to which the welding torch 200 is attached drives the tip end of the welding wire 211 along an approximate straight line indicated by a virtual line IL in FIG. 4 with respect to the X-axis direction while tilting the welding torch 200 when the crank 170 pivots as indicated by an arrow R₂ illustrated in FIGS. 3 and 4. The mechanism moving in the X-axis direction in the present embodiment includes the X-axis movement mechanism 181 and the approximate linear movement mechanism 180 described above, and regardless of which mechanism is used, the description will be simply referred to as “X-axis direction”.

The welding torch rotation drive portion 116 is rotatably attached to the fixing arm portion 114 as indicated by an arrow R₁ in FIG. 2, and can be adjusted to an optimum angle and fixed.

As described above, the robot main body 110 can drive the welding torch 200, which is a tip end portion of the robot main body 110, with four degrees of freedom, that is, the approximate linear movement mechanism 180, the X-axis movement mechanism 181, the Y-axis movement mechanism 182, and the Z-axis movement mechanism 183, with respect to three directions, that is, the X-axis direction, the Y-axis direction, and the Z-axis direction. The robot main body 110 is not limited thereto, and may be driven with any number of degrees of freedom according to the purpose.

With the above configuration, a tip end portion of the welding wire 211 of the welding torch 200 attached to the torch connection portion 130 can be directed in any direction. That is, the robot main body 110 can be driven on the guide rail 120 in the X-axis direction. The welding torch 200 can be driven in the Y-axis direction, which is the width direction of the groove 10, or in the Z-axis direction, which is the depth direction of the groove 10. In addition, the welding torch 200 can be tilted by driving with the crank 170 according to a working situation, for example, to provide a push angle or a retreat angle.

An attachment member 140 such as a magnet is provided below the guide rail 120, and the guide rail 120 is easily attached to and detached from the workpiece Wo by the attachment member 140. When the portable welding robot 100 is set on the workpiece Wo, an operator can easily set the portable welding robot 100 on the workpiece Wo by grasping both side handles 160 of the portable welding robot 100.

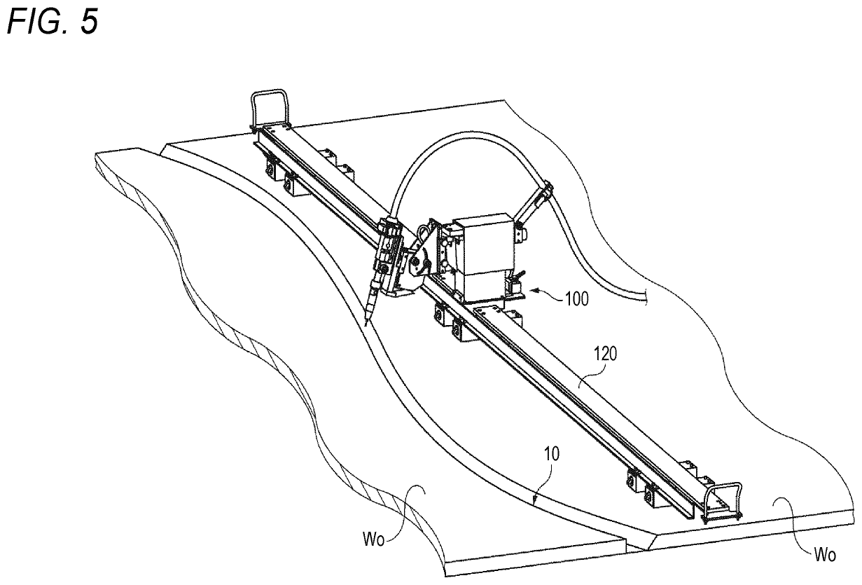

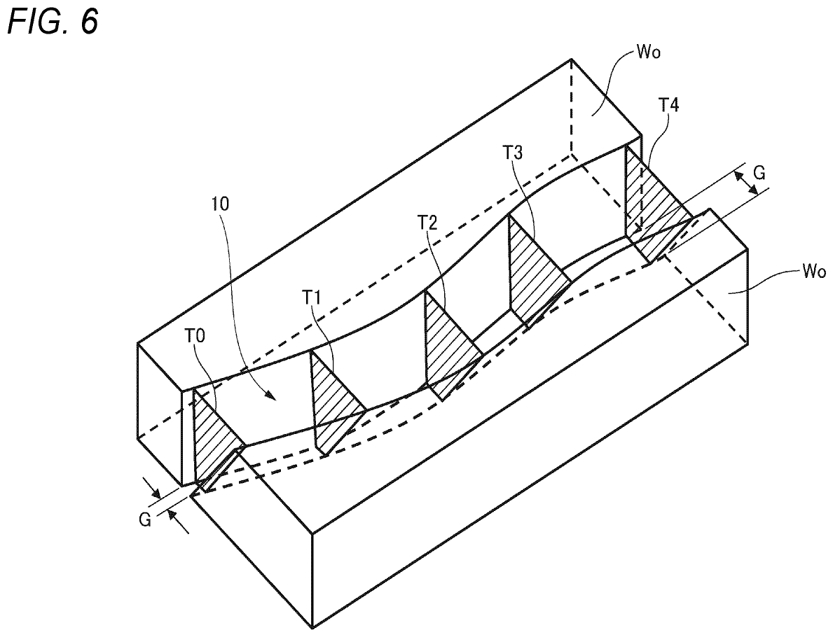

FIG. 5 is a schematic perspective view illustrating a case in which the portable welding robot 100 is disposed on the straight guide rail 120 with respect to the groove 10 including a curve according to the embodiment of the present disclosure. FIG. 6 is a perspective view illustrating a plurality of detection positions according to the embodiment of the present disclosure.

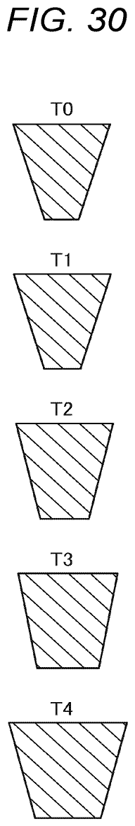

When a weld joint is long, the groove 10 of welding may include a curve as illustrated in FIG. 5. In addition, sensing data (a root gap, a groove angle, and a staggered amount) may vary depending on a place at which sensing is performed. In the example of FIG. 6, in addition to a welding start point T0 and a welding end point T4, sensing is performed at a total of five detection positions, including three points (T1, T2, T3) therebetween. The number of times of sensing to be applied between the welding start point T0 and the welding end point T4 is set in advance so as to perform sensing at equal intervals, and sensing can be performed while automatically moving the welding robot main body, or sensing can be performed manually at fine intervals when a welding line is largely bent. At this time, groove shapes at the plurality of detection positions T0 to T4 may be different from each other as illustrated in FIG. 30. FIG. 30 is a conceptual diagram illustrating the groove shapes at the plurality of detection positions according to the embodiment of the present disclosure.

### Acquisition of Welding Condition Information

Examples of a simplified process for acquiring welding execution information and welding condition information before welding include the following (A) to (C).
(A) In the control device 600, a welding mode corresponding to items such as a type of welding wire, a type of shield gas, and a welding position in the welding execution information is determined, and a condition acquisition and correction database (hereinafter, also referred to as a “condition acquisition and correction DB”) for each welding mode is determined. The condition acquisition and correction DB may be stored in, for example, the memory of the control device 600, or may be stored in the storage device of another device capable of communicating with the control device 600.
(B) The robot main body 110 is driven based on an operation signal of the control device 600, and automatic sensing of the groove shapes is started using the touch sensor.
(C) The groove shape information is calculated by the above automatic sensing, and working conditions, welding conditions, and the like are acquired based on the groove shape information and the condition acquisition and correction DB, or the welding conditions or the like set in advance are corrected.

Examples of the welding conditions include a welding current, a feeding speed, an arc voltage, a travel speed, a weaving width, and a target position of wire. The present invention is not limited thereto.

### Sensing Step Before Welding

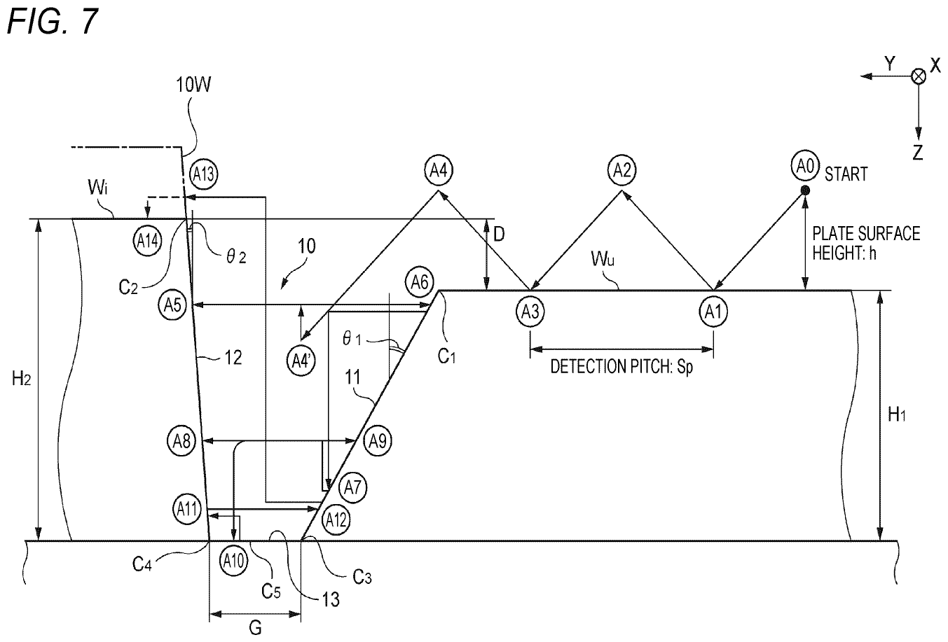

A sensing step before the start of welding is performed by touch-sensing the groove shapes, the plate thickness, start and end parts, and the like with the touch sensor. FIG. 7 is a schematic diagram illustrating the touch sensing according to the embodiment of the present disclosure. The tip end of the welding wire 211 is moved to each position of A0 to A14 in FIG. 7 to sense a shape of a workpiece. By specifying positions when the tip end of the welding wire 211 touches the workpiece, for example, A1, A3, A5, A6, and the like, the above groove shapes, plate thickness, start and end parts, and the like can be specified.

After the sensing step, a groove shape information calculation step of calculating groove shape information based on detection data of a groove cross-sectional shape at each groove shape detection position obtained in the sensing step is performed. Here, examples of the groove shape information include a groove angle of the groove shape, the plate thickness, a groove depth, an estimated welded metal height, a gap, and a distance between workpiece ends.

After the groove shape information calculation step, a step of inputting the calculated data as a set value to the data holding unit 601 is performed. In the present embodiment, in the groove shape information calculation step, at least one of the plate thickness, the groove depth, and the estimated welded metal height and the gap are calculated as the groove shape information, and are input to the data holding unit 601 as set values. In the groove shape information calculation step, when the gap is smaller than the wire diameter of the welding wire, a gap amount may be calculated as 0.

Next, setting conditions in teaching program data are corrected or set based on the data input to the data holding unit 601 as the set values and the condition acquisition and correction DB. In the present embodiment, for example, the welding current, the arc voltage, the travel speed, and the weaving condition are set or corrected. The setting or correction means that the setting is performed when the set values are not yet set, and the set values are corrected when the set values are already set.

### Lamination Design

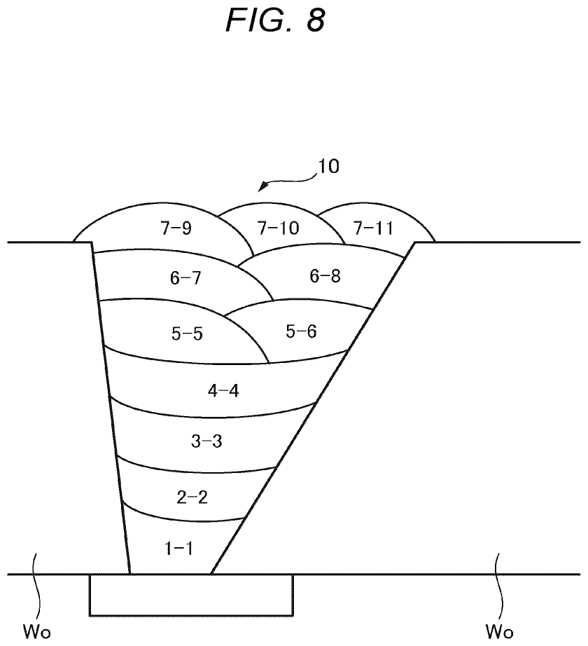

FIG. 8 is a conceptual diagram illustrating a lamination design according to the embodiment of the present disclosure. The lamination design refers to determining the appropriate number of layers and the appropriate number of paths for a given groove. The term “layer” means the number of times of welding beads stacked in a plate thickness direction. In the example of FIG. 8, seven layers of welding beads are stacked. A reference sign 1-1 corresponds to a first layer. A reference sign 2-2 corresponds to a second layer. A reference sign 3-3 corresponds to a third layer. A reference sign 4-4 corresponds to a fourth layer. Reference signs 5-5 and 5-6 correspond to a fifth layer. Reference signs 6-7 and 6-8 correspond to a sixth layer. Reference signs 7-9, 7-10, and 7-11 correspond to a seventh layer. The number of lamination layers in the example of FIG. 8 is seven. The path means the number of welding beads, that is, the number of times of welding. The number of paths in the example of FIG. 8 is 11. For example, the seventh layer includes three paths.

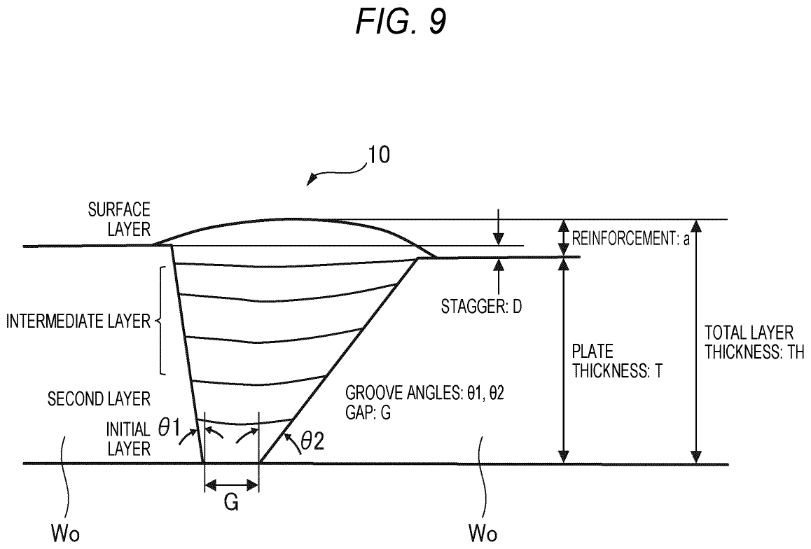

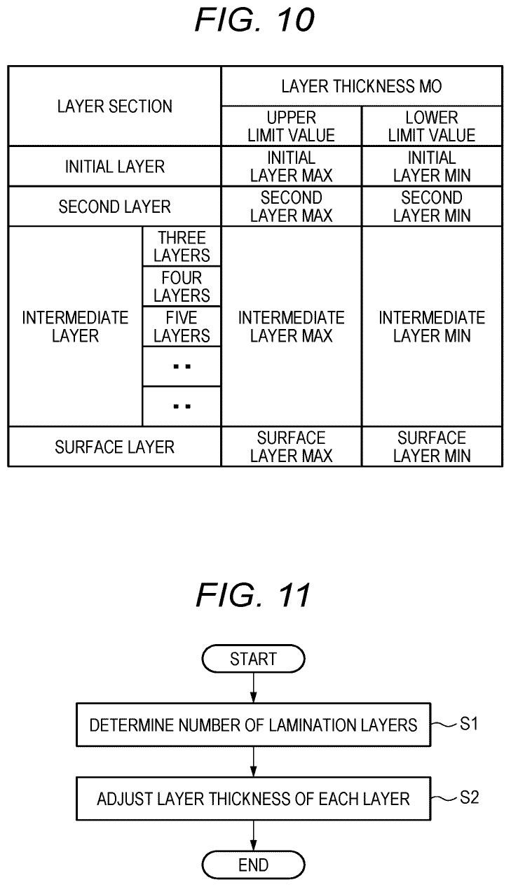

FIG. 9 is a schematic cross-sectional view of a weld joint according to the embodiment of the present disclosure. FIG. 10 is a diagram illustrating layer thickness information according to the embodiment of the present disclosure.

The groove shapes are detected at a plurality of detection positions of the weld joint by the above touch sensing or the like. The groove shape data includes groove angles θ1 and θ2, a root gap G, a plate thickness T, a total layer thickness TH, and a stagger D. The total layer thickness TH corresponds to a sum of the plate thickness T and a reinforcement a, and it is advisable to input any value for the reinforcement a in advance.

The control device 600 calculates a reference groove shape based on detection data of the groove shapes at the plurality of positions.

The reference groove shape may be, for example, a shape based on an average value of the detection data of the groove shapes at the plurality of positions. Referring also to FIG. 6, an average value of the plate thickness T, an average value of the stagger D, average values of the respective groove angles θ1 and θ2, an average value of the root gap G, and the like are calculated by averaging the detection data obtained at the five detection positions T0 to T4, and a groove shape defined by these values is set as a reference groove shape.

The reference groove shape may be calculated by using a method other than the average values. For example, the control device 600 may calculate a reference groove shape based on a minimum value, a maximum value, a median value, or the like of the plurality of pieces of detection data.

Next, the control device 600 calculates the number of lamination layers and a layer thickness required to complete a weld joint based on the calculated reference groove shape. The layer thickness means a bead thickness in the plate thickness direction in a welding 1 path. An example of a method for calculating the number of lamination layers and a layer thickness will be described later.

The number of lamination layers and the layer thickness are included in lamination information. The number of lamination layers and a layer thickness for the reference groove shape are included in reference lamination information. The lamination information and the reference lamination information may include information other than the number of lamination layers or the layer thickness, for example, the number of paths.

### Determination of Number of Lamination Layers and Layer Thickness

The control device 600 determines the number of lamination layers and a layer thickness of each layer based on the layer thickness information. The layer thickness information may be stored in, for example, the memory of the control device 600, or may be stored in the storage device of the other device capable of communicating with the control device 600. The layer thickness information is information indicating an allowable range of the layer thickness of the layer. The layer thickness information may be a fixed value or range information defined by an upper limit value and a lower limit value. Hereinafter, the layer thickness information will be described as the range information defined by the upper limit value and the lower limit value.

In the present embodiment, layers are classified into four layer sections, that is, an initial layer, a second layer, an intermediate layer, and a surface layer according to properties of lamination positions to be described later. The memory stores layer thickness information such as table data in which an upper limit value and a lower limit value of a layer thickness are determined for each layer section in advance. The reinforcement a and an allowable range, that is, an upper limit value and a lower limit value of a layer thickness MO illustrated in FIG. 10 are selected from an appropriate range by overlapping welding tests in advance for each combination of shield gas, a wire material, a wire diameter, a base metal, and a welding position to be used. In the present embodiment, each of the layer sections, that is, the initial layer, the second layer, and the surface layer includes one layer, and the layer section of the intermediate layer includes one or more layers. When the number of layers is larger than a total of three layers of the initial layer, the second layer, and the surface layer, the number of intermediate layers increases layer by layer.

The control device 600 determines the number of lamination layers based on a numerical value of the total layer thickness TH and the layer thickness information so that each layer of the initial layer, the second layer, the intermediate layer, and the surface layer falls within the allowable range defined in the layer thickness information. A determination algorithm for the number of lamination layers will be described in detail later.

The four types of layer sections are given priorities. A priority for determining the number of lamination layers and a layer thickness is as follows.
Priority 1 is the initial layer. The initial layer is the first welding, and is a most important layer in terms of welding quality in which heat first enters the base metal, and the penetration into the base metal is emphasized.
Priority 2 is the surface layer. The surface layer affects an appearance of the weld joint and does not induce defects such as undercuts and overlaps, and thus the surface layer is a second most important layer in terms of welding quality after the initial layer.
Priority 3 is the second layer. The second layer is a layer that has a narrow groove gap, takes into consideration that heat input reaches the base metal properly, and has no influence on welding quality.
Priority 4 is the intermediate layer. The intermediate layer is a portion that becomes a thickest layer when a plate thickness increases, and thus the intermediate layer is a layer that needs to be emphasized on welding efficiency.

In the above example, in performing the lamination design, Priority 1 is a highest priority, and Priority 4 is a lowest priority.

### Determination Algorithm for Number of Lamination Layers and Layer Thickness

FIG. 11 is a flowchart illustrating a determination processing of the number of lamination layers and the layer thickness according to the embodiment of the present disclosure. The control device 600 determines the number of lamination layers and the layer thickness such that the layer thickness of each layer becomes the upper limit value as the priority of each layer section is higher. This is to ensure necessary and sufficient heat input and perform stable welding by setting the layer thickness to the upper limit value as the priority of the layer section is higher. Therefore, the determination algorithm is, for example, as follows.

In step S1, the control device 600 determines the number of lamination layers. More specifically, the control device 600 adds layers in order from a layer of a layer section with a high priority to a layer of a layer section with a low priority from Priority 1 to Priority 4. Along with the addition of layers, the control device 600 sequentially adds upper limit values of layer thicknesses corresponding to the added layers to a cumulative addition value. An initial value of the cumulative addition value is 0, and when a first layer is added, the cumulative addition value is equal to an upper limit value of a layer thickness corresponding to the first layer.

As the number of added layers increases, the cumulative addition value monotonically increases. Thus, when a timing at which the cumulative addition value becomes equal to or larger than a total layer thickness TH arrives, the control device 600 determines that the number of layers already added at this timing is the desired number of lamination layers.

A specific example of the determination algorithm for the number of lamination layers will be described. For example, when a total of three layers of the initial layer, the surface layer, and the second layer are laminated in descending order of priority, a cumulative addition value obtained by adding respective upper limit values is initial layer MAX+surface layer MAX+second layer MAX based on the notation in FIG. 10. However, the initial layer MAX+surface layer MAX+second layer MAX, which is the cumulative addition value, is smaller than the total layer thickness TH.

Further, the cumulative addition value when one intermediate layer is added is initial layer MAX+surface layer MAX+second layer MAX+intermediate layer MAX. It is assumed that the initial layer MAX+surface layer MAX+second layer MAX+intermediate layer MAX, which is the cumulative addition value, is equal to or larger than the total layer thickness TH. That is, it is assumed that the cumulative addition value becomes equal to or larger than the total layer thickness TH at the timing when one intermediate layer is added. The control device 600 determines that the number of layers already added at this timing, that is, a total of four layers consisting of the initial layer, the surface layer, the second layer, and one intermediate layer is the desired number of lamination layers.

When step S1 is completed, the number of lamination layers has already been ended. In subsequent step S2, the control device 600 determines the layer thickness of each layer in the determined number of lamination layers. For example, when the layer thicknesses of the initial layer, the surface layer, the second layer, and the intermediate layer are each at the upper limit value, a cumulative addition value obtained by adding the four upper limit values may exceed the total layer thickness TH. Therefore, in step S2, the layer thickness of each layer is adjusted so that the cumulative addition value becomes equal to the total layer thickness TH.

As a method of adjusting a layer thickness, for example, the layer thickness is decreased from the upper limit value toward the lower limit value in ascending order of priority, that is, in order of Priority 4, Priority 3, Priority 2, and Priority 1. The more specific description is as follows.

In step S2-1, the control device 600 sets the layer thickness of each layer to an upper limit value corresponding to the layer section of each layer.

In step S2-2, if the cumulative addition value coincides with the total layer thickness TH, the layer thickness of each layer at this time is an appropriate value, and thus an adjustment processing is ended at this time.

In step S2-3, when the cumulative addition value does not coincide with the total layer thickness TH, a layer thickness of a layer section having a lowest priority is reduced so as not to fall below the lower limit value corresponding to the layer section.

The above step S2-3 will be described more specifically by exemplifying a case in which a layer to be adjusted is the intermediate layer. Difference S=cumulative addition value−total layer thickness TH. If intermediate layer MIN≤intermediate layer MAX−difference S, the control device 600 determines that the layer thickness of the intermediate layer to be adjusted=intermediate layer MAX−difference S, and ends the adjustment processing. A layer thickness of a layer not to be adjusted may be maintained at the upper limit value.

$$The difference S at the above time point = initial layer MAX + surface layer MAX + second layer MAX + intermediate layer MAX - total layer thickness TH . Therefore , the following equation holds .$$

$$Layer thickness of intermediate layer to be adjusted = total layer thickness TH - ( initial layer MAX + surface layer MAX + second layer MAX )$$

On the other hand, when intermediate layer MIN>intermediate layer MAX−difference S, if it is determined that the layer thickness of the intermediate layer to be adjusted=intermediate layer MAX−difference S, the layer thickness of the intermediate layer falls below the lower limit value, which is inappropriate. That is, in this case, the cumulative addition value and the total layer thickness TH cannot appropriately coincide with each other by only adjusting a layer thickness of one layer. Therefore, when intermediate layer MIN>intermediate layer MAX−difference S, in step S2-4, the control device 600 sets the layer thickness of the layer that has already been adjusted to the lower limit value, and then sets another layer as a next layer to be adjusted. At this time, a new cumulative addition value is calculated in the state in which the layer thickness of the layer that has already been adjusted is set to the lower limit value. In the above specific example, the new cumulative addition value=initial layer MAX+second layer MAX+intermediate layer MIN+surface layer MAX.

As the next layer to be adjusted, a layer having the same priority as that of a layer that has been adjusted most recently or having a higher priority than that of the layer that has been adjusted most recently is selected. In addition, a layer having a lowest priority is selected.

For example, when there are a total of six layers consisting of an initial layer, a second layer, an intermediate layer A, an intermediate layer B, an intermediate layer C, and a surface layer, the intermediate layer A, the intermediate layer B, the intermediate layer C, the second layer, the surface layer, and the initial layer are to be adjusted in this order according to the priority.

In step S2-5, processing subsequent to step S2-2 is repeated based on the new layer to be adjusted and the new cumulative addition value.

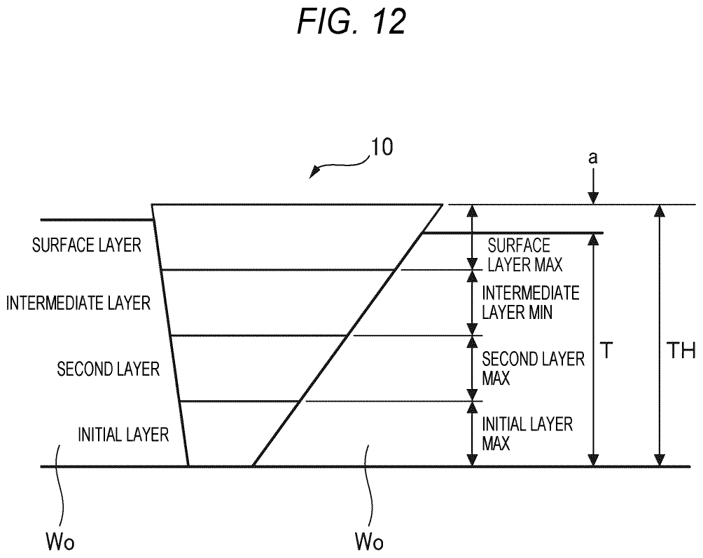

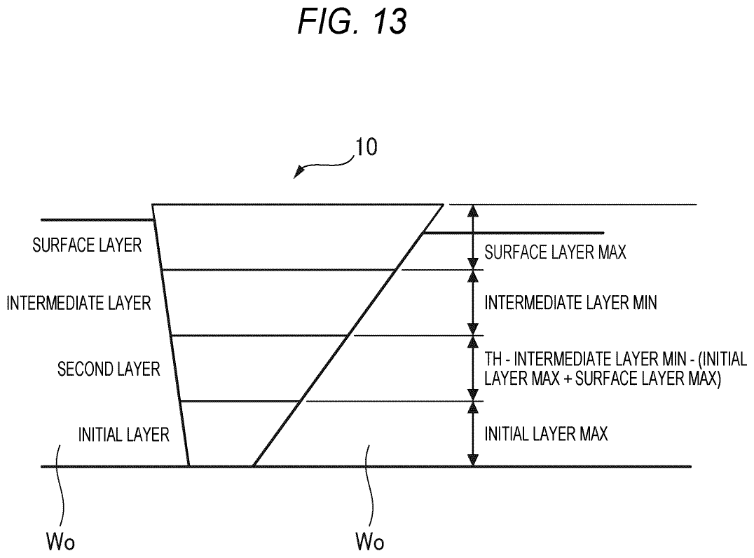

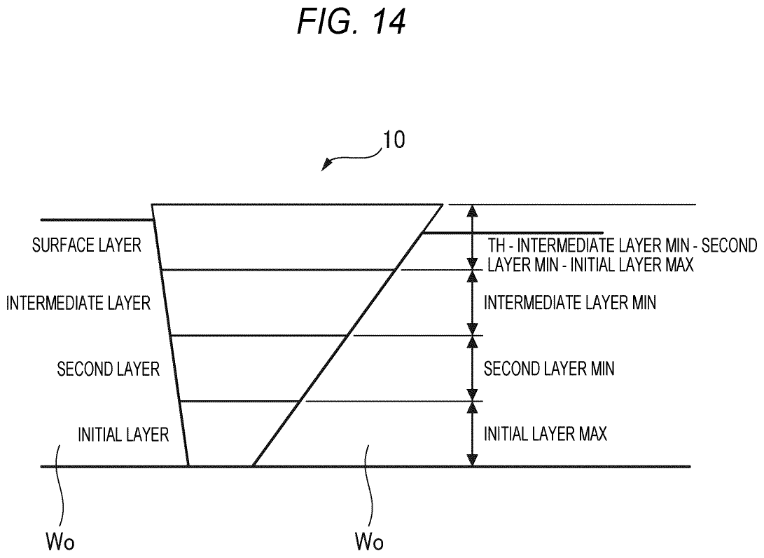

FIG. 12 is a conceptual diagram illustrating a situation in which a layer thickness of the intermediate layer of priority 4 is set to the lower limit value. FIG. 13 is a conceptual diagram illustrating a situation in which the layer thickness of the second layer of priority 3 is reduced from the upper limit value to an appropriate value. FIG. 14 is a conceptual diagram illustrating a situation in which the layer thickness of the surface layer of priority 2 is reduced to an appropriate value. As illustrated in FIGS. 12 to 14, first the layer thickness of the intermediate layer is adjusted, next the layer thickness of the second layer is adjusted, and then the layer thickness of the surface layer is adjusted.

For example, by performing the above adjustment processing, a layer section having a high priority, that is, important in terms of welding quality can maintain the number of lamination layers while ensuring sufficient heat input and stabilizing welding, and can cause the cumulative addition value to coincide with the total layer thickness TH while keeping the layer thickness of each layer within the allowable range.

When the cumulative addition value coincides with the total layer thickness TH, the number of lamination layers and the layer thickness of each layer are determined.

### Determination of Number of Paths for Each Layer

The number of lamination layers and the layer thickness of each layer are determined, and thus the control device 600 determines the number of paths on each layer. The control device 600 sets a distribution threshold HS as a parameter for determining the number of paths, and compares the distribution threshold HS with a layer width SW to be calculated to calculate the number of paths for each layer.

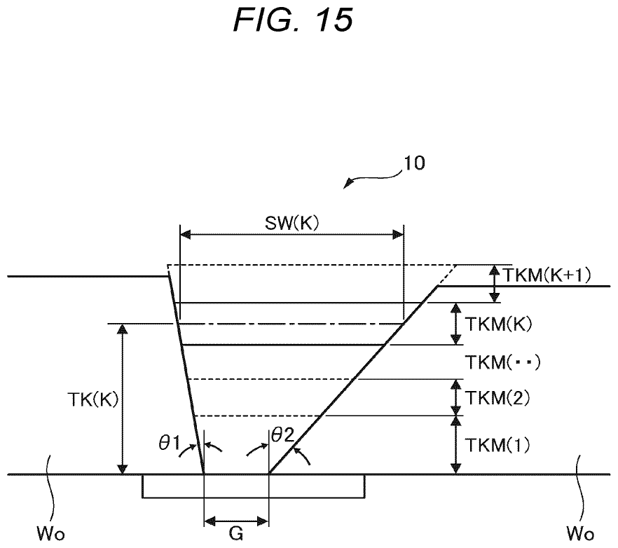

FIG. 15 is a conceptual diagram illustrating a layer width according to the embodiment of the present disclosure. A layer width of a K-th layer, that is, a K-th layer counted from a bottom surface side of the groove is SW (K). SW (K) is a linear distance between both the groove walls in a layer central portion of the K-th layer. The layer central portion corresponds to a portion indicated by an alternate long and short dash line in FIG. 15. A layer thickness of the K-th layer is TKM (K). A distance from a bottom surface of the groove to the layer central portion of the K-th layer is TK (K).

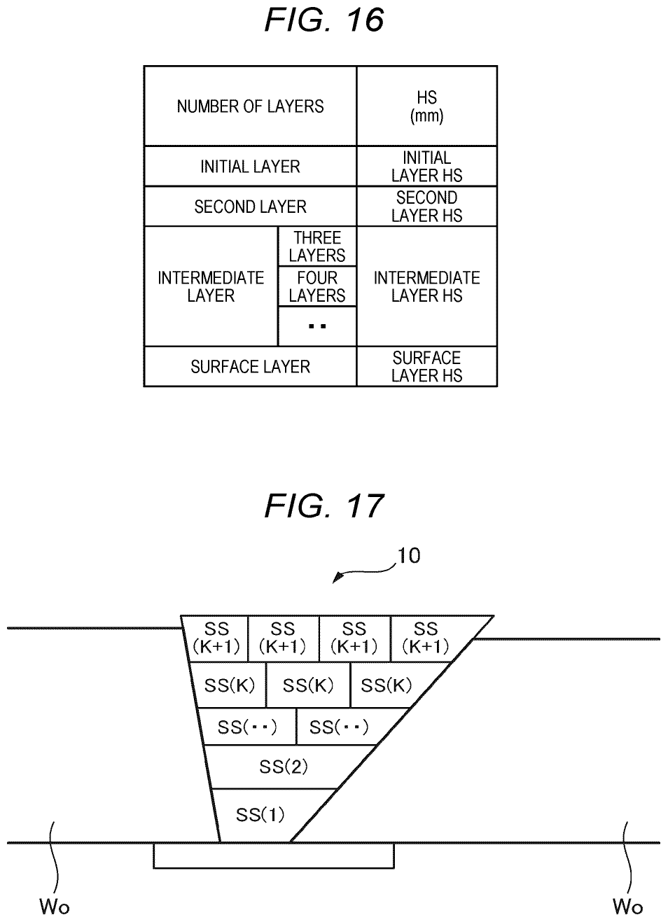

FIG. 16 is a diagram illustrating distribution threshold information according to the embodiment of the present disclosure. The distribution threshold information is set for each layer section as illustrated in FIG. 16. The distribution threshold information may be stored in, for example, the memory of the control device 600, or may be stored in the storage device of the other device capable of communicating with the control device 600. When the layer width SW exceeds the distribution threshold HS, the control device 600 determines that the layer is a layer to be distributed. As a set value included in the distribution threshold information, an appropriate value is set in advance in a welding test for each combination of the shield gas, the wire material, the wire diameter, the base metal, and the welding position to be used.

Referring to FIG. 15 again, the distance TK (K) is represented by the following equation.

$$\begin{matrix}[ Formula 1 ] & \\ TK ( K ) = TKM ( 1 ) + TKM ( 2 ) + … + TKM ( K - 1 ) + \frac{1}{2} TKM ( K ) & ( 4 - 1 )\end{matrix}$$

Based on Equation (4-1), the layer width SW (K) of the K-th layer is represented by the following equation.

$$\begin{matrix}[ Formula 2 ] & \\ SW ( K ) = TK ( K ) \cdot ( tan θ1 + tan θ2 ) + G & ( 4 - 2 )\end{matrix}$$

The number of paths HP is obtained by dividing the layer width SW (K) of the K-th layer by the distribution threshold HS, truncating a fraction, and adding 1. That is, the following equation is obtained.

$$\begin{matrix}[ Formula 3 ] & \\ HP ( K ) = INT ( \frac{SW ( K )}{HS} ) + 1 & ( 4 - 3 )\end{matrix}$$

FIG. 17 is a conceptual diagram illustrating distribution paths for each layer and a cross-sectional area for each path according to the embodiment of the present disclosure.

The number of paths HP on the K-th layer is determined as described above, and thus a cross-sectional area SS (K) per path of the K-th layer is obtained according to the following equation by dividing a cross-sectional area of the K-th layer by the number of paths.

$$\begin{matrix}[ Formula 4 ] & \\ SS ( K ) = \frac{SW ( K )}{HP ( K )} \cdot TKM ( K ) & ( 4 - 4 )\end{matrix}$$

The control device 600 calculates distribution of paths for all layers and an area for each path based on the above calculation formula. As illustrated in FIG. 17, in a layer consisting of a plurality of paths, a cross-sectional area for each path is set to be equal.

### Setting of Welding Conditions

Next, the setting of welding conditions will be described.

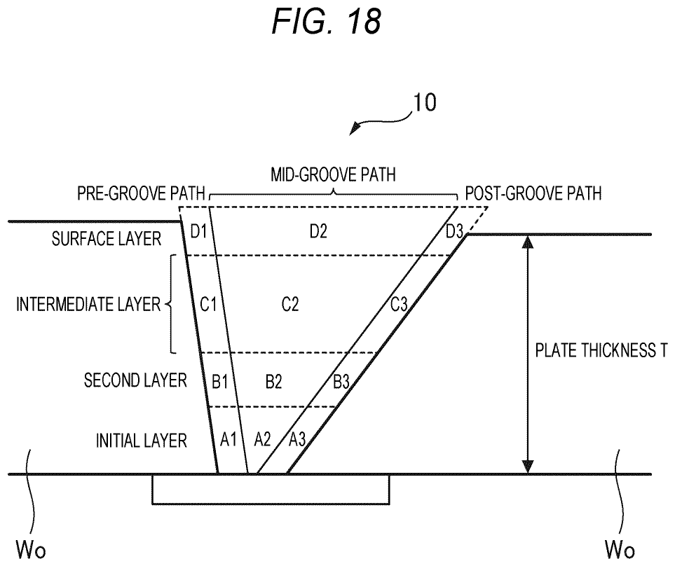

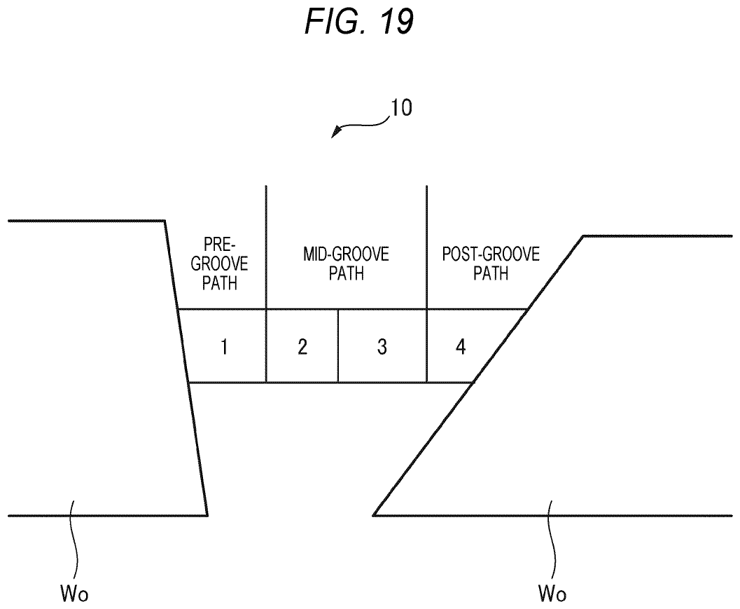

FIG. 18 is a conceptual diagram illustrating path classification according to the embodiment of the present disclosure. FIG. 19 is a conceptual diagram illustrating a case in which there are a plurality of mid-groove paths according to the embodiment of the present disclosure. In the present embodiment, the paths are classified into three path positions for each layer section of the initial layer, the second layer, the intermediate layer, and the surface layer. The three path positions are a pre-groove path, a mid-groove path, and a post-groove path.

The pre-groove path is a path in contact with a front groove wall (a groove on a left side with respect to FIG. 18). The post-groove path is a path in contact with a rear groove wall (a groove on a right side with respect to FIG. 18). The mid-groove path is a path in an intermediate portion between the pre-groove path and the post-groove path. When the number of paths in one layer becomes three or more, the layer is provided with a mid-groove path. In addition, as illustrated in FIG. 19, when the number of paths in one layer becomes four or more, the layer is provided with a plurality of mid-groove paths.

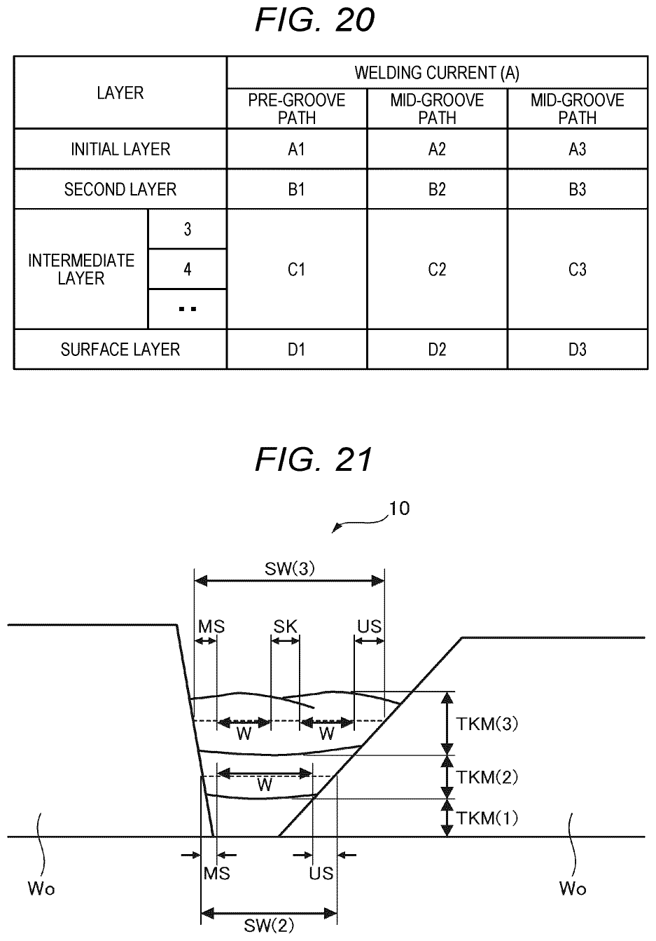

FIG. 20 is a diagram illustrating welding current information according to the embodiment of the present disclosure. The welding current information includes values of welding currents for each layer section at the above three path positions. The welding condition set for each path position is not limited to the welding current, and may be, for example, an arc voltage, a feeding speed, or the like, or may be set by combining a plurality of welding conditions. The welding current is an important condition for considering the welding quality and is regarded as a main factor among various welding conditions, and thus it is preferred to use the welding current as in the present embodiment. The welding current information may be stored in, for example, the memory of the control device 600, or may be stored in the storage device of the other device capable of communicating with the control device 600.

The control device 600 determines a welding current and an arc voltage of each path. The welding current is a factor that most affects the penetration into the base metal, and is an important setting item among the welding conditions.

As illustrated in FIG. 20, as the welding current information, the value of the welding current of each path is set for each path position from the following viewpoint.

Path positions A1, A2, and A3 in the initial layer are set to a high current to obtain the penetration of the base metal.

Path positions B1, C1, B3, and C3 in the pre-groove path and the post-groove path of the second layer and the intermediate layer are set to a high current to obtain the penetration of the base metal.

Path positions D1 and D3 in the pre-groove path and the post-groove path of the surface layer are set to a medium current so as not to cause an undercut of the surface.

Path positions B2, C2, and D2 in the mid-groove path of the second layer, the intermediate layer, and the surface layer are set to a medium current to stably form a welded metal.

As a whole, in consideration of a state in which preheating occurs as the welding proceeds from the initial layer, the current is set so as to be changed from a high current to a medium current as the welding proceeds from the initial layer, the second layer, and the intermediate layer.

A relation rule with the number of paths HP for each layer is determined as follows.

When the number of paths HP is 1, a welding current of the mid-groove path is set.

When the number of paths HP is 2, welding currents of the pre-groove path and the post-groove path are set.

When the number of paths HP is 3 or more, first, the pre-groove path and the post-groove path are selected, the remaining path is set as the mid-groove path, and welding currents are set for each path.

After a welding current I of each path is determined, the control device 600 calculates a weld amount F (I) (mm³/min) of the welding wire according to the following equation.

$$\begin{matrix}[ Formula 5 ] & \\ F ( I ) = AA \cdot {I}^{2} + BB \cdot I + CC & ( 5 - 1 )\end{matrix}$$

Here, AA, BB, and CC are coefficients determined according to the type and diameter of the welding wire.

Next, the control device 600 calculates the travel speed. As described above with reference to FIG. 17, the cross-sectional area SS (mm²) of each path has been calculated, and thus a travel speed V (mm/min) is obtained according to the following equation.

$$\begin{matrix}[ Formula 6 ] & \\ V = \frac{F ( I )}{SS} & ( 5 - 2 )\end{matrix}$$

The control device 600 obtains an arc voltage VOL according to the following equation.

$$\begin{matrix}[ Formula 7 ] & \\ VOL ( I ) = DD \cdot {I}^{2} + EE \cdot I + FF & ( 5 - 3 )\end{matrix}$$

Here, DD, EE, and FF are coefficients determined according to the type and diameter of the welding wire.

As described above, the control device 600 calculates the welding current, the arc voltage, the travel speed, and the like, which are main welding conditions of each path.

### Determination of Weaving Width and Target Position of Wire for Each Path

The control device 600 determines the weaving width and the target position of the wire for each path. Here, the weaving width is a width of reciprocation when the welding torch swings in a groove width direction. That is, the weaving width is also a weaving width of the tip end of the welding wire 211 located at a tip of the welding torch. The target position of the wire indicates a position at which the tip end of the welding wire 211 needs to be disposed at a predetermined desired position with respect to the groove shape at the time of starting a welding arc.

When the arc is brought too close to the groove wall in order to obtain sufficient penetration into the groove wall, the groove wall is melted by the arc at once, and the melted base metal flows and is dug into the groove. As a result, there is a possibility that the welding beads cannot be laminated. On the other hand, when the arc is excessively separated from the groove wall, the groove wall is insufficiently melted. That is, in order to obtain appropriate welding quality, there is an appropriate distance to bring the arc close to the groove wall, and when the target position of the arc is appropriately determined, it is necessary to consider a wire target position at which a distance between the tip end of the welding wire 211 and the groove wall becomes appropriate.

In a layer in which path distribution occurs, it is necessary to form the layer while the welding beads are appropriately lapped. In order that the adjacent beads are not too far from each other and are not too close to each other to form a layer having a constant layer thickness, it is necessary to consider that a lap width, that is, an overlap width between the adjacent beads is appropriate.

In one-path welding, there is a method for obtaining a uniform bead width by periodically swinging the welding torch in the groove width direction, and the swinging operation is generally referred to as weaving or oscillating, and a width in which the welding torch reciprocates is referred to as a weaving width in the embodiment of the present disclosure as described above. It is necessary to determine the weaving width in consideration of an approach distance to the groove wall and the lap width between the beads in the distribution path.

Therefore, the control device 600 determines an appropriate weaving width for each path and an appropriate target position of the wire.

FIG. 21 is a conceptual diagram illustrating parameters for determining an appropriate target position of the wire according to the embodiment of the present disclosure.

The parameters for determining an appropriate target position of the wire are hereinafter referred to as target position parameters. The target position parameters are set for each layer section. There are three types of target position parameters, that is, a pre-groove remaining MS, a post-groove remaining US, and a distribution lap width SK.

The pre-groove remaining MS indicates a distance between the groove wall and the

tip end of the welding wire 211 at which a welding arc does not excessively melt a front groove wall (a groove on a left side with respect to FIG. 21) and good penetration is obtained.

The post-groove remaining US indicates a distance between the groove wall and the tip end of the welding wire 211 at which the welding arc does not excessively melt a rear groove wall (a groove on a right side with respect to FIG. 21) and good penetration is obtained.

The distribution lap width SK means a lap width between adjacent beads in a layer serving as a distribution path.

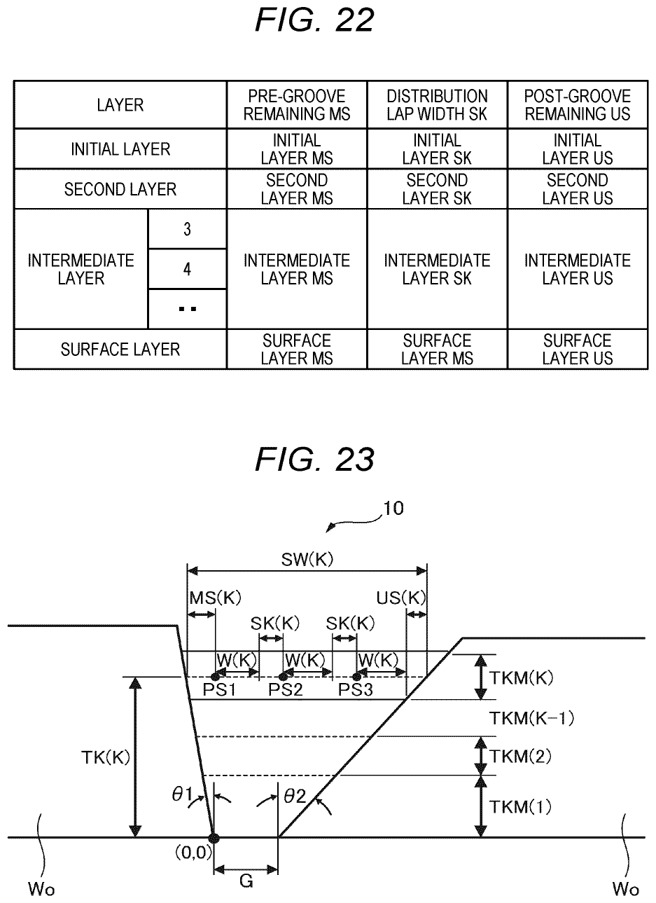

FIG. 22 is a diagram illustrating target position parameters according to the embodiment of the present disclosure. The target position parameters may be stored in, for example, the memory of the control device 600, or may be stored in the storage device of the other device capable of communicating with the control device 600. The welding test is repeated in advance for each combination of the shield gas, the wire material, the diameter of the welding wire, the presence or absence of a back sheet metal, the groove shape, and the welding position to be used, and an appropriate value of the target position parameters is selected.

The control device 600 calculates a weaving width W by which the welding torch swings in the groove width direction based on the target position parameters. The arc generated from the tip end of the welding wire 211 has directivity, and thus when disturbance such as magnetic blowing does not occur, the arc operates in the same manner by the weaving of the welding torch.

FIG. 23 is a conceptual diagram illustrating target position parameters according to the embodiment of the present disclosure. The control device 600 calculates a weaving width W (K) in one path of the K-th layer based on the layer width SW (K) of the K-th layer, a pre-groove remaining MS (K), a post-groove remaining US (K), and a distribution lap width SK (K) which are set in the K-th layer, and the number of paths HP (K) on the K-th layer according to the following equation.

$$\begin{matrix}[ Formula 8 ] & \\ W ( K ) = \frac{SW ( K ) - MS ( K ) - SK ( K ) \cdot ( HP ( K ) - 1 ) - US ( K )}{HP ( K )} & ( 5 - 4 )\end{matrix}$$

SW(K) can be obtained according to Equation (4-2), and HP(K) can be obtained according to Equation (4-3).

The target position of the wire in each path is a starting end of the weaving width W (K). The starting end of the weaving width W (K) corresponds to a position of a circle plotted above each of reference signs PS1, PS2, and PS3 in FIG. 23.

When the welding torch oscillates while reciprocating a distance W in a predetermined cycle, the arc operates in the same manner as the welding torch because the arc has directivity as described above. TK (K), MS (K), W (K), and SK (K) are known, and thus for example, when a gap end of the bottom surface of the groove is set to a position of an origin, that is, a position of coordinates (0, 0) in FIG. 23, the control device 600 can geometrically obtain coordinates of the target position of the wire in the K-th layer.

### Target Position of Wire when Weaving Width is 0

In Equation (5-4), W (K)21 0 may be satisfied. In this case, W=0. That is, the wire is fixed without weaving to perform direct welding, that is, welding in a straight bead. A procedure in which the control device 600 determines the target position of the wire when W=0 will be described later.

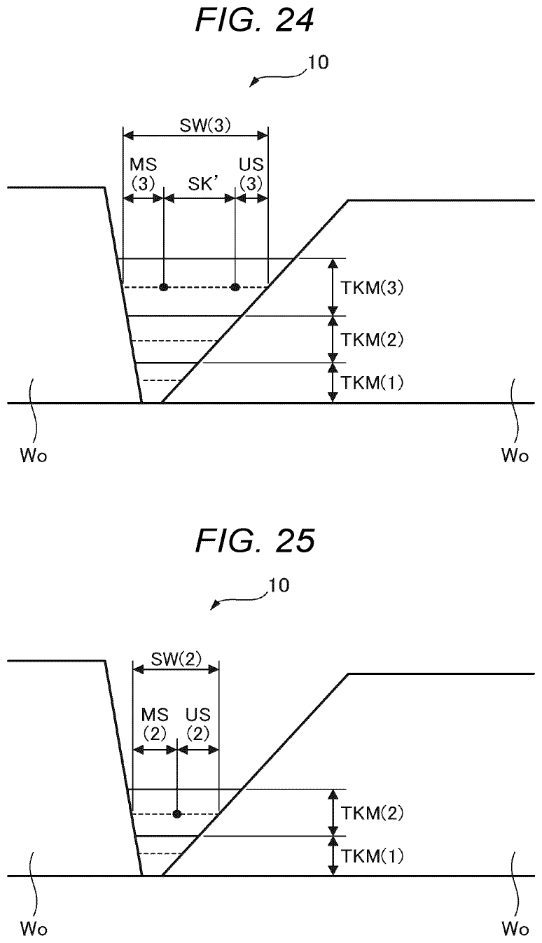

FIG. 24 is a conceptual diagram illustrating target positions of the wire when W=0 and HP>2 according to the embodiment of the present disclosure. When W=0 and HP≥2, the following equation is obtained by setting SK (K) as SK′ according to Equation (5-4).

$$\begin{matrix}[ Formula 9 ] & \\ {SK}^{′} = \frac{SW ( K ) - MS ( K ) - US ( K )}{HP ( K ) - 1} & ( 5 - 8 )\end{matrix}$$

The control device 600 changes the already set SK (K) to SK′ obtained according to the above equation and determines the target position of the wire. As illustrated in FIG. 24, welding is performed in a straight bead with a circle as a wire target position.

FIG. 25 is a conceptual diagram illustrating a target position of the wire when W=0 and HP=1 according to the embodiment of the present disclosure. When W=0 and HP=1, the following equation is obtained according to Equation (5-4).

$$\begin{matrix}[ Formula 10 ] & \\ {MS}^{′} = \frac{MS ( K )}{MS ( K ) + US ( K )} \cdot SW ( K ) & ( 5 - 10 )\end{matrix}$$

A connection point between MS and US is the target position of the wire. The circle in FIG. 25 is the target position of the wire, and welding is performed in a straight bead.

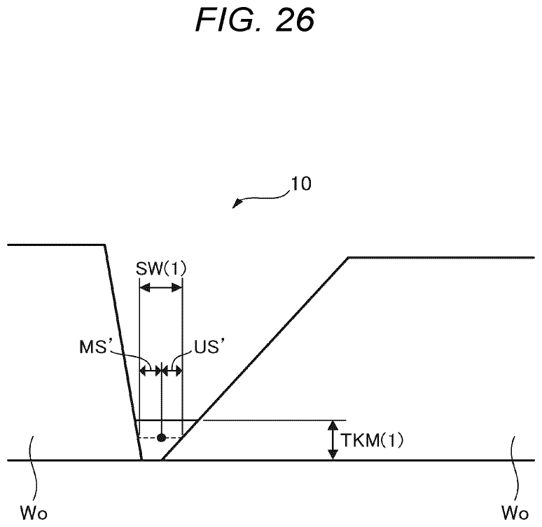

FIG. 26 is a conceptual diagram illustrating a target position of the wire when W=0, HP=1, and SW (K)<MS (K)+US (K) according to the embodiment of the present disclosure. In this case, MS and US are replaced with MS′ and US′ newly obtained according to the following equations such that a ratio of MS to US does not change.

$$\begin{matrix}[ Formula 11 ] & \\ {MS}^{′} = \frac{MS ( K )}{MS ( K ) + US ( K )} \cdot SW ( K ) & ( 5 - 10 )\end{matrix}$$

$$\begin{matrix}[ Formula 12 ] & \\ {US}^{′} = \frac{US ( K )}{MS ( K ) + US ( K )} \cdot SW ( K ) & ( 5 - 11 )\end{matrix}$$

That is, the control device 600 determines the target position of the wire in the same manner as in the case of FIG. 25 while maintaining an interval ratio of MS to US.

### Management of Parameters

The control device 600 manages the necessary parameters used for the lamination design and the welding condition determination by dividing the parameters into the layer sections, that is, the initial layer, the second layer, the intermediate layer, and the surface layer. Here, the lamination design refers to the setting of the number of layers and the number of paths, and the welding condition determination refers to the determination of the welding current, the arc voltage, the travel speed, the wire target position, and the weaving width of each path.

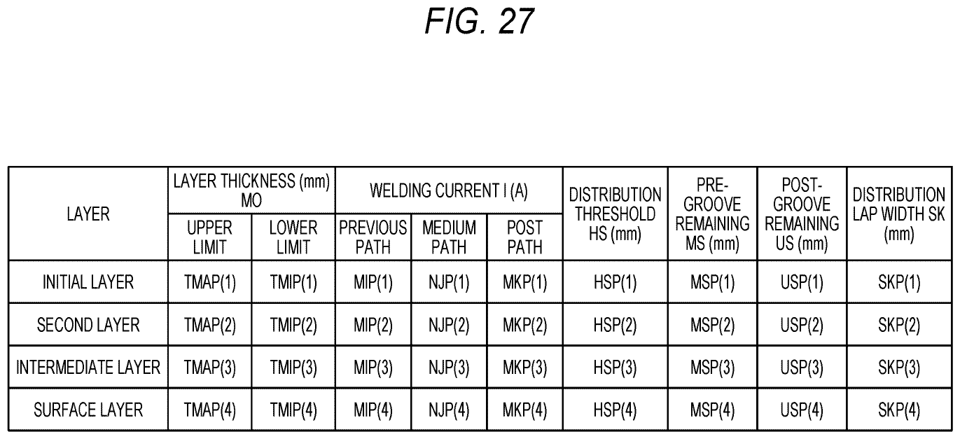

FIG. 27 is a diagram illustrating a management table that manages parameters related to the determination of the number of layers, the number of paths, a wire target position, and a weaving width according to the embodiment of the present disclosure. The management table stores, for each layer section, values of parameters such as the layer thickness MO, the welding current I, the distribution threshold HS, the pre-groove remaining MS, the post-groove remaining US, and the distribution lap width SK.

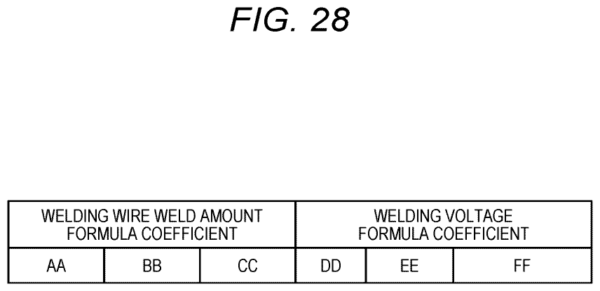

FIG. 28 is a diagram illustrating a management table that manages parameters related to the determination of a weld amount and an arc voltage according to the embodiment of the present disclosure. AA, BB, and CC, which are welding wire weld amount formula coefficients, correspond to Equation (5-1). DD, EE, and FF, which are arc voltage formula coefficients, correspond to Equation (5-3).

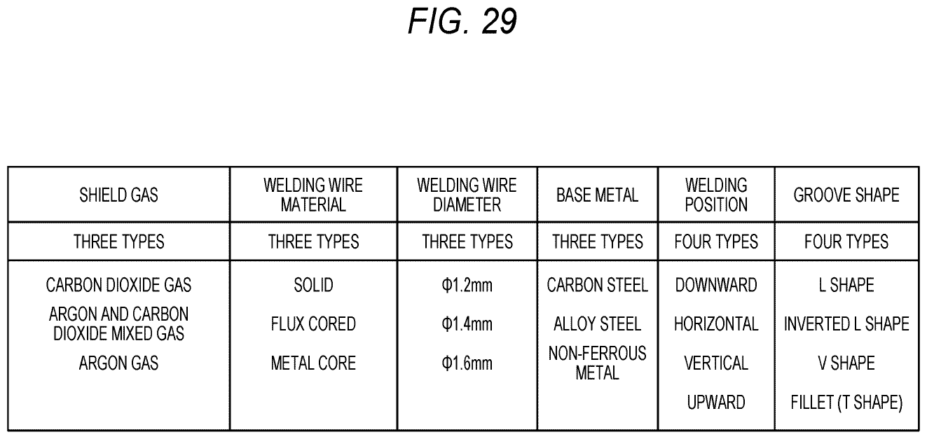

FIG. 29 is a diagram illustrating selection items of welding according to the embodiment of the present disclosure. The values of the various parameters illustrated in FIGS. 27 and 28 are set in advance by finding appropriate values through a welding test in advance for each combination of shield gas, a welding wire material, a welding wire diameter, a base metal, a welding position, and a groove shape which are a plurality of selection items illustrated in FIG. 29. By setting various parameters in advance according to the combination of the selection items, the lamination design and the welding condition determination described above can be executed for any combination of the plurality of selection items.

The parameters to be managed or the management table may be stored in, for example, the memory of the control device 600, or may be stored in the storage device of the other device capable of communicating with the control device 600. The parameters to be managed may be stored in a database format. The parameters to be managed may be collectively managed in a format of one table or the like. The parameters to be managed may be managed in a distributed manner in a format of a plurality of tables or the like.

### Lamination Design and Welding Conditions for Groove Shape at Sensing Position

In the above embodiment, the lamination design is performed on the reference groove shape calculated based on sensing data at a plurality of detection positions, that is, a plurality of sensing positions illustrated in FIG. 6, and the welding conditions of each path are determined. As illustrated in FIG. 30, the groove shape may be different depending on the sensing position.

For example, in a workpiece as illustrated in FIG. 5, welding is continuously performed from the start to the end of welding by causing the portable welding robot 100 to travel on the rail. Therefore, even through there is a variation in the groove shape from the start to the end of welding, the number of layers and the number of paths of the welding beads in the groove must all be the same.

On the other hand, from the viewpoint of welding quality, the weld joint after being welded needs to satisfy a designed welding bead width and weld reinforcement height without defects such as undercut and overlap over an entire wire. That is, at the sensing position, the number of layers and the number of paths of the welding beads are all the same, and appropriate lamination design must be performed and appropriate welding conditions must be set for each groove shape at each sensing position.

Therefore, a lamination design method and a welding condition setting method for groove shapes at the plurality of sensing positions will be described later.

The lamination design and the welding condition determination for the groove shape at the sensing position are performed based on the lamination design and the welding conditions for the reference groove shape.

1) The control device 600 determines the number of lamination layers, the layer thickness, and the number of paths for the groove shape at the sensing position. The layer thickness of each layer corresponding to the groove shape at each sensing position is obtained based on a ratio of a plate thickness of the reference groove shape to a plate thickness of the groove shape at each sensing point with respect to the layer thickness obtained based on the reference groove shape. That is, the following equation is obtained.

$$\begin{matrix}[ Formula 13 ] & \\ LAYER THICKNESS OF EACH LAYER OF GROOVE SHAPE AT SENSING POSITION = ( PLATE THICKNESS OF GROOVE AT SENSING POSITION / PLATE THICKNESS OF REFERENCE GROOVE SHAPE ) \cdot LAYER THICKNESS OF EACH LAYER OF REFERENCE GROOVE SHAPE & ( 10 - 1 )\end{matrix}$$

The number of lamination layers corresponding to the groove shape at the sensing position is the same as the number of lamination layers corresponding to the reference groove shape, and according to the above equation, the layer thickness increases or decreases relatively depending on the plate thickness ratio. The number of paths is the same as the number of paths of the reference groove shape even in the groove shape at the sensing position. The number of paths on each layer obtained according to Equation (4-3) is directly adopted as the number of paths on each layer corresponding to the groove shape at the sensing position.

2) Next, the control device 600 obtains the weaving width and the target position of the wire for the groove shape at the sensing position. The weaving width of each layer with respect to the groove shape at the sensing position is obtained based on a ratio of the layer width of each layer obtained based on the reference groove shape to the layer width of each layer with respect to the groove shape at the sensing position, with respect to the weaving width of each layer with respect to the reference groove shape. That is, the following equation is obtained.

$$\begin{matrix}[ Formula 14 ] & \\ WEAVING WIDTH OF EACH LAYER OF GROOVE SHAPE AT SENSING POSITION = ( LAYER WIDTH OF EACH LAYER OF GROOVE SHAPE AT SENSING POSITION / LAYER WIDTH OF EACH LAYER OF REFERENCE GROOVE SHAPE ) \cdot WEAVING WIDTH OF EACH LAYER OF REFERENCE GROOVE SHAPE & ( 10 - 2 )\end{matrix}$$

The layer width of each layer with respect to the groove shape at the sensing position can be calculated based on the data on the groove shape at the sensing position and the number of lamination layers and the layer thickness obtained in the above 1) using Equation (4-2) in which the layer width is obtained based on the reference groove shape.

According to Equation (10-2), the weaving width of each layer in the groove shape at the sensing position is obtained by increasing or decreasing the weaving width of each layer in the reference groove shape according to the layer width ratio.

The target position of the wire of each layer with respect to the groove shape at the sensing position is geometrically obtained in the same manner by drawing the same figure as FIG. 23 for the groove shape at the sensing position. At this time, as the pre-groove remaining MS, the post-groove remaining US, and the distribution lap width SK necessary for obtaining the target position of the wire, relative values from the MS, US, and SK used in the reference groove shape are calculated by using the layer width ratio in the same way as in Equation (10-2), and are adopted.

3) The control device 600 obtains the travel speed in the groove shape at the sensing position. A travel speed of each layer in the groove shape at the sensing position is obtained based on a ratio of a cross-sectional area of one path obtained according to Equation (4-4) used in the reference groove shape to a cross-sectional area of one path in the groove shape at the sensing position, with respect to a travel speed of each layer in the reference groove shape. That is, the ratio of the two cross-sectional areas is a product of the plate thickness ratio used in Equation (10-1) and the layer width ratio used in Equation (10-2). When the welding current is constant, the travel speed is inversely proportional to an increase or decrease in a cross-sectional area per unit length in which the welded metal is deposited, and thus the travel speed of each layer in the groove shape at the sensing position is calculated according to the following equation.

$$\begin{matrix}[ Formula 15 ] & \\ TRAVEL SPEED OF EACH LAYER IN GROOVE SHAPE AT SENSING POSITION = ( PLATE THICKNESS OF REFERENCE GROOVE SHAPE / PLATE THICKNESS OF GROOVE SHAPE AT SENSING POSITION ) \cdot ( LAYER WIDTH OF EACH LAYER OF REFERENCE GROOVE SHAPE / LAYER WIDTH OF EACH LAYER OF GROOVE SHAPE AT SENSING POSITION ) \cdot TRAVEL SPEED OF EACH LAYER OF REFERENCE GROOVE SHAPE & ( 10 - 3 )\end{matrix}$$

A welding current and an arc voltage in the groove shape at the sensing position are the same as a welding current and an arc voltage applied in the reference groove shape.

The welding current and the arc voltage directly affect a welding arc phenomenon, and thus making the welding current and the arc voltage constant without being changed is a prerequisite for obtaining stable welding quality. Therefore, the welding current and the arc voltage are set to be constant from the start to the end of welding.

As described above, the same lamination design (the number of layers and the number of paths) is performed for the groove shapes at all the sensing positions based on the reference groove shape, and the welding conditions (the welding current, the arc voltage, the weaving width, and the wire target position) can be set according to the groove shape at each sensing position.

Although various embodiments have been described above with reference to the drawings, it is needless to say that the present disclosure is not limited to such examples. It is apparent that those skilled in the art can conceive of various modifications and alterations within the scope described in the claims, and it is understood that such modifications and alterations naturally fall within the technical scope of the present disclosure. In addition, the respective constituent elements in the above embodiments may be freely combined without departing from the gist of the disclosure.

An execution order of each processing such as the operations, the procedures, the steps, and the stages in the device, the system, the program, and the method shown in the claims, the specification, and the drawings is not particularly specified as “before” or “prior to”, and can be implemented in any order as long as the output of the previous processing is not used in the subsequent processing. Regarding an operation flow in the claims, the specification, and the drawings, even though the description is made using “first”, “next”, and the like for convenience, it does not mean that it is essential to perform the operation in this order.

Although various embodiments have been described above with reference to the drawings, it is needless to say that the present invention is not limited to such examples. It is apparent that those skilled in the art can conceive of various modifications and alterations within the scope described in the claims, and it is understood that such modifications and alterations naturally fall within the technical scope of the present invention. In addition, the respective constituent elements in the above embodiments may be freely combined without departing from the gist of the invention.

The present application is based on Japanese Patent Application No. 2022-071123 filed on Apr. 22, 2022, the contents of which are incorporated herein by reference.

### INDUSTRIAL APPLICABILITY

The present disclosure is useful for a lamination design method, a welding condition setting method, a welding control method, a welding control device, and a welding system capable of generally and easily setting welding conditions regardless of whether long welding is performed or not while securing welding quality.

### REFERENCE SIGNS LIST

10: groove
50: welding system
100: portable welding robot
110: robot main body
112: main body portion
113: slide support portion
114: fixing arm portion
116: welding torch rotation drive portion
120: guide rail
130: torch connection portion
132: torch clamp
134: torch clamp
140: member
150: cable clamp
160: both side handles
168: rotation shaft
169: sliding table
169a: long groove
170: crank
171: coupling pin
172: fixing pin
180: approximate linear movement mechanism
181: X-axis movement mechanism
182: Y-axis movement mechanism
183: Z-axis movement mechanism
200: welding torch
210: nozzle
211: welding wire
300: feeding device
400: welding power source
410: power cable
420: conduit tube
430: power cable
500: shield gas supply source
510: gas tube
600: control device
601: data holding unit
602: groove shape information calculation unit
603: welding condition acquisition unit
604: control unit
610: robot control cable
620: power source control cable

1. A lamination design method for performing multilayer overlay welding on a material to be welded provided with a groove shape using a welding robot, the lamination design method comprising:
detecting a plurality of the groove shapes;
calculating reference groove shape data based on a detected plurality of pieces of groove shape data;
calculating at least the number of lamination layers and a layer thickness of each layer as reference lamination information based on the reference groove shape data; and
calculating the number of lamination layers and a layer thickness of each layer as lamination information of each detection position based on the reference groove shape data, the groove shape data of each detection position, and the reference lamination information.

2. The lamination design method according to claim 1, wherein
the number of lamination layers and the layer thickness of each layer, which are the reference lamination information, are calculated based on at least
a total layer thickness obtained based on the reference groove shape data, and
layer thickness information predetermined for each of a plurality of layer sections into which the number of lamination layers is classified based on a predetermined classification condition.

3. The lamination design method according to claim 2, wherein
the layer thickness information is provided with an allowable range of the layer thickness for each of the layer sections, and
based on a predetermined priority for each of the layer sections and the allowable range,
the number of lamination layers and the layer thickness of each layer, which are the reference lamination information, are calculated.

4. The lamination design method according to claim 3, wherein
the allowable range includes an upper limit value and a lower limit value,
the upper limit value of the layer thickness is added in descending order of priority for each of the layer sections, and
the number of lamination layers when a cumulative addition value obtained by the addition becomes equal to or larger than the total layer thickness for a first time is determined as the number of lamination layers which is the reference lamination information.

5. The lamination design method according to claim 2, wherein
the plurality of layer sections include at least four layer sections, that is, an initial layer, a second layer, and a surface layer each consisting of one layer, and an intermediate layer consisting of one or more layers, and
priority of the layer sections is the initial layer, the surface layer, the second layer, and the intermediate layer in descending order of priority.

6. The lamination design method according to claim 2, wherein
a distribution threshold, which is a maximum amplitude amount of weaving, is predetermined for each of the layer sections,
a layer width, which is a distance between both groove end surfaces of each layer, is calculated based on the number of lamination layers as the reference lamination information, and
the number of paths and a path cross-sectional area of each layer are calculated based on the distribution threshold for each of the layer sections and the layer width of each layer.

7. The lamination design method according to claim 6, wherein
the layer width of each layer is compared with the distribution threshold of each layer, and
the number of paths and the path cross-sectional area of each layer are calculated based on a ratio of the layer width to the distribution threshold for the layer having the layer width larger than the distribution threshold.

8. The lamination design method according to claim 2, wherein
the layer thickness information or the distribution threshold for each of the layer sections is determined for each welding mode, and
the welding mode is defined by at least one or a plurality of combinations of a shield gas type, a composition of a welding material, a wire diameter of the welding material, a composition of a base metal, a welding position, and a groove type.

9. A welding condition setting method for determining a welding condition, comprising:
determining and setting at least one welding condition among a welding current, a feeding speed, an arc voltage, a travel speed, a weaving width, and a target position of a wire based on the reference lamination information or the lamination information of each detection position calculated in the lamination design method according to claim 1.

10. The welding condition setting method according to claim 9, wherein
the welding condition is set according to at least one of the number of paths and a path position on a layer for each of layer sections into which the number of lamination layers is classified based on a predetermined classification condition.

11. The welding condition setting method according to claim 10, wherein
information indicating the welding condition corresponding to the path position is stored in a storage device for each of the layer sections, and
the welding condition corresponding to the path position is set based on the information indicating the welding condition corresponding to the path position and the number of paths for each layer.

12. The welding condition setting method according to claim 11, wherein
the information indicating the welding condition corresponding to the path position includes information indicating a welding current,
a weld amount and an arc voltage are calculated based on the information indicating a welding current, and
a travel speed is calculated based on the calculated weld amount, and a path cross-sectional area calculated according to a layer width of each layer and a distribution threshold which is a maximum amplitude amount of weaving for each of the layer sections.

13. The welding condition setting method according to claim 9, wherein
a plurality of parameters related to the weaving width corresponding to each layer section are stored in a storage device, and
the weaving width or the target position of the wire among the welding conditions is calculated based on at least the parameters, the layer width of each layer, and the number of paths on each layer.

14. The welding condition setting method according to claim 13, wherein
the plurality of parameters related to the weaving width include, at least
a first parameter which is an interval between one groove surface and an appropriate position at which a welding wire is close to the one groove surface,
a second parameter which is an interval between another groove surface and an appropriate position at which the welding wire is close to the another groove surface, and
a third parameter which is a lap width between adjacent beads in a case in which the number of paths on a layer is plural.

15. A welding control method for performing multilayer overlay welding on a material to be welded provided with a groove shape using a welding robot, the welding control method comprising:
a groove shape detection step of detecting a plurality of the groove shapes;
a reference groove shape calculation step of calculating reference groove shape data based on a detected plurality of pieces of groove shape data;
a reference lamination information calculation step of calculating at least the number of lamination layers and a layer thickness of each layer as reference lamination information based on the reference groove shape data;
a welding condition setting step of determining and setting at least one welding condition among a welding current, an arc voltage, a travel speed, and a weaving width based on the reference lamination information; and
a detection position calculation step of calculating lamination information of each detection position or a welding condition of each detection position based on at least one of the reference lamination information and the welding condition, the reference groove shape data, and the groove shape data of each detection position.

16. The welding control method according to claim 15, wherein
the reference groove shape data and the groove shape data of each detection position include at least one item among a plate thickness, a total layer thickness, and a layer width, and
in the detection position calculation step,
the lamination information of each detection position or the welding condition of each detection position is calculated based on a ratio of an item included in the reference groove shape data to a corresponding item included in the groove shape data of each detection position and at least one of the reference lamination information and the welding condition.

17. A welding control device for performing multilayer overlay welding on a material to be welded provided with a groove shape using a welding robot, the welding control device comprising:
a groove shape detection function of detecting a plurality of the groove shapes;
a reference groove shape calculation function of calculating reference groove shape data based on a detected plurality of pieces of groove shape data;
a reference lamination information calculation function of calculating at least the number of lamination layers and a layer thickness of each layer as reference lamination information based on the reference groove shape data;
a welding condition setting function of determining and setting at least one welding condition among a welding current, an arc voltage, a travel speed, and a weaving width based on the reference lamination information; and
a detection position calculation function of calculating lamination information of each detection position or a welding condition of each detection position based on at least one of the reference lamination information and the welding condition, the reference groove shape data, and the groove shape data of each detection position.

18. (canceled)
